(19) United States
(12) Patent Application Publication
(10) Pub. No.: US 2026/0302156 A1
(43) Pub. Date: Oct. 1, 2026

(54) APPARATUS AND METHOD FOR MANUFACTURING ELECTRODE

(71) Applicant: SK ON CO., LTD., Seoul (KR)

(72) Inventors: Hyun Soo KIM, Daejeon (KR); Min Sang KIM, Daejeon (KR); Jong Bok PARK, Daejeon (KR); Sang Hwa LEE, Daejeon (KR)

(21) Appl. No.: 19/560,137

(22) Filed: Mar. 9, 2026

(30) Foreign Application Priority Data
Mar. 25, 2025 (KR) 10-2025-0038316

(51) Int. Cl. H01M 4/04

(52) U.S. Cl. CPC H01M 4/0404

(57) ABSTRACT

Proposed are an apparatus and a method for manufacturing an electrode. The apparatus comprises a defect inspection line configured to sense a defect in an electrode sheet traveling in a first direction and attach a label indicating the defect to the electrode sheet, a rewinder configured to rewind the electrode sheet having passed through the defect inspection line to produce an electrode roll, an unwinder configured to unwind the electrode roll and cause the electrode sheet to travel in a second direction, and a defect removal line configured to sense the label attached to the electrode sheet output from the unwinder and remove a portion of the electrode sheet in which the defect is present, wherein a position at which the label indicating the defect is attached is a position shifted from the defect by a shift interval based on the first direction.

### CROSS REFERENCE TO RELATED APPLICATION

The present application claims priority to Korean Patent Application No. 10-2025-0038316, filed on Mar. 25, 2025, the entire contents of which is incorporated herein for all purposes by this reference.

### TECHNICAL FIELD

The present disclosure relates to an apparatus and a method for manufacturing an electrode.

### BACKGROUND

A secondary battery is a battery that can be repeatedly charged and discharged. Battery cells are widely used for various applications, comprising electric vehicles, portable electronics, and energy storage systems. A battery cell is manufactured by housing electrodes (anode and cathode), a separator, and an electrolyte within a casing. The electrodes are produced by applying a slurry containing active material onto a current collector, followed by processes such as drying, pressing, and cutting. A roll-to-roll (R2R) apparatus may be used in the production of battery electrodes. The roll-to-roll apparatus unwinds a roll of material, performs processes, and rewinds the processed electrode to produce an electrode roll.

### SUMMARY

According to an aspect of the present disclosure, there are provided an apparatus and a method for manufacturing an electrode, which detect defects in an electrode sheet, attach a label indicating a defect to the electrode sheet at a predetermined distance behind the defect, produce an electrode roll by winding the electrode sheet, unwind the electrode roll, and recognize the label preceding the defect during electrode notching to remove the defective portion of the electrode sheet.

According to an aspect of the present disclosure, there are provided an apparatus and a method for manufacturing an electrode, wherein a distance by which a label trails a defect on an electrode sheet is determined based on a minimum labeling cycle interval enabling a labeler to continuously attach labels.

An apparatus and a method for manufacturing an electrode according to an aspect of the present disclosure can be applied to the manufacturing processes of batteries widely used in green technology fields, such as electric vehicles, battery charging stations, and other battery-utilizing applications comprising solar and wind power generation.

An apparatus and a method for manufacturing an electrode according to an aspect of the present disclosure can be applied to the manufacturing processes of batteries used in eco-friendly electric vehicles (EVs), hybrid vehicles (HVs), and other similar applications, thereby contributing to the reduction of air pollution and greenhouse gas emissions for the purpose of mitigating climate change.

According to an aspect of the present disclosure, an apparatus for manufacturing an electrode may comprise: a defect inspection line configured to sense a defect in an electrode sheet traveling in a first direction and attach a label indicating the defect to the electrode sheet; a rewinder configured to rewind the electrode sheet having passed through the defect inspection line to produce an electrode roll; an unwinder configured to unwind the electrode roll and cause the electrode sheet to travel in a second direction; and a defect removal line configured to sense the label attached to the electrode sheet output from the unwinder and remove a portion of the electrode sheet in which the defect is present, wherein a position at which the label indicating the defect is attached may be a position shifted from the defect by a shift interval based on the first direction.

According to an embodiment, the defect inspection line may comprise: a defect sensor configured to capture the electrode sheet; a labeler configured to attach a label to the electrode sheet; and a first controller configured to analyze images captured by the defect sensor to determine whether a defect is present in the electrode sheet and control the labeler to attach a label to the electrode sheet.

According to an embodiment, the first controller may analyze images received from the defect sensor to recognize a position of a current defect on the electrode sheet and determines whether the current defect is comprised in a previously set first zone or second zone, and in case that the current defect is not comprised in the previously set first zone or second zone, may control the labeler to attach a label at a position shifted by the shift interval from the position of the current defect, and may set a first zone and a second zone starting from the position of the current defect.

According to an embodiment, in case that the current defect is comprised in the previously set first zone or second zone, the first controller may determine whether the current defect is located within the first zone, and may control the labeler so as not to attach a label when the current defect is located in the first zone, and may control the labeler to attach a label at a position shifted by the shift interval from an end point of the second zone when the current defect is not located within the first zone, and may further perform an operation of setting a first zone and a second zone starting from the end point of the second zone.

According to an embodiment, the defect removal line may comprise: a label sensor configured to sense a label attached to the electrode sheet traveling in the second direction from the unwinder; a notcher configured to perform notching to create a tab on the electrode sheet; a cutter configured to cut the electrode sheet to separate the sheet into unit electrodes; and a second controller that, when a label is present on the electrode sheet, controls the notcher so as not to perform notching on a predetermined number of consecutive unit electrodes starting from and comprising a unit electrode to which the label is attached, based on the second direction, and controls the cutter so as not to separate the predetermined number of consecutive unit electrodes starting from and comprising the unit electrode to which the label is attached, based on the second direction, and that, when a portion of the electrode sheet corresponding to the unit electrode to which the label is attached and the predetermined number of consecutive unit electrodes has passed, controls the notcher to perform notching to create a tab on a portion of the electrode sheet without a defect, and controls the cutter to cut the notched electrode sheet at predetermined intervals to separate the sheet into unit electrodes.

According to an embodiment, the position shifted by the shift interval may be a position trailing the defect by the shift interval with respect to the first direction, and the defect removal line may remove a unit electrode to which the label is attached and a predetermined number of unit electrodes trailing the unit electrode to which the label is attached with respect to the second direction after determining the unit electrode to which the label is attached and the predetermined number of unit electrodes trailing the unit electrode to which the label is attached to be a portion of the electrode sheet in which a defect is present.

According to an embodiment, the shift interval may be set within a range in which a minimum length corresponds to a length of the first zone corresponding to a minimum labeling interval of a labeler plus an error gap during label attachment by the labeler, and a maximum length corresponds to a size of a unit electrode.

According to an embodiment, the position shifted by the shift interval may be a position preceding the defect by the shift interval with respect to the first direction, and the defect removal line may remove a unit electrode to which the label is attached and a predetermined number of unit electrodes preceding the unit electrode to which the label is attached with respect to the second direction after determining the unit electrode to which the label is attached and the predetermined number of unit electrodes preceding the unit electrode to which the label is attached to be a portion of the electrode sheet in which a defect is present.

According to an embodiment, the shift interval may be set to a length of an error gap during label attachment by a labeler.

According to an aspect of the present disclosure, a method for manufacturing an electrode may comprise: sensing, on a defect inspection line, a defect in an electrode sheet traveling in a first direction and attaching a label indicating the defect to the electrode sheet; rewinding, by a rewinder, the electrode sheet having passed through the defect inspection line to produce an electrode roll; unwinding, by an unwinder, the electrode roll so that the electrode sheet travels in a second direction; and sensing, on a defect removal line, the label attached to the electrode sheet output from the unwinder and removing a portion of the electrode sheet in which the defect is present, wherein a position at which the label indicating the defect is attached may be a position shifted from the defect by a shift interval based on the first direction.

According to an embodiment, the attaching of the label indicating the defect may comprise: capturing, by a defect sensor, the electrode sheet; recognizing, by a first controller, a position of a current defect on the electrode sheet by analyzing images received from the defect sensor; determining (a first determination step) whether the current defect is comprised in a previously set first zone or second zone; attaching a label at a position shifted by the shift interval from the position of the current defect in case that the current defect is not comprised in the previously set first zone or second zone; and setting a first zone and a second zone starting from the position of the current defect.

According to an embodiment, the attaching of the label indicating the defect may further comprise: determining (a second determination step) whether the current defect is located within the first zone when the current defect is comprised in the previously set first zone or second zone; not attaching, in case that the current defect is located within the first zone, the label and returning to the capturing of the electrode sheet, in which the defect sensor captures the electrode sheet; attaching, in case that the current defect is not located within the first zone, the label at a position shifted by the shift interval from an end point of the second zone; and setting a first zone and a second zone starting from the end point of the second zone.

According to an embodiment, the removing of the portion of the electrode sheet in which the defect is present may comprise: capturing, by a label sensor, the electrode sheet; determining, by a second controller, whether a label is present on the electrode sheet by analyzing an image received from the label sensor; controlling (a pass step), by the second controller, a notcher so as not to perform notching on a predetermined number of consecutive unit electrodes starting from and comprising a unit electrode to which the label is attached, based on the second direction, and a cutter so as not to separate the predetermined number of consecutive unit electrodes starting from and comprising the unit electrode to which the label is attached, based on the second direction, in case that the label is present on the electrode sheet; determining, by the second controller, whether a portion of the electrode sheet corresponding to the unit electrode to which the label is attached and the predetermined number of consecutive unit electrodes has passed; controlling, by the second controller, the notcher to perform notching to create a tab on the electrode sheet, and the cutter to cut the notched electrode sheet at predetermined intervals to separate the notched electrode sheet into unit electrodes, in case that the portion of the electrode sheet corresponding to the unit electrode to which the label is attached and the predetermined number of consecutive unit electrodes has passed; and removing, by the second controller, a continuous portion of the electrode sheet corresponding to the unit electrode to which the label is attached and the predetermined number of consecutive unit electrodes in the second direction, in case that the portion of the electrode sheet corresponding to the unit electrode to which the label is attached and the predetermined number of consecutive unit electrodes has passed.

According to an embodiment, the position shifted by the shift interval may be a position trailing the defect by the shift interval with respect to the first direction, and the removing of the portion of the electrode sheet in which the defect is present may involve removing a unit electrode to which the label is attached and a predetermined number of unit electrodes trailing the unit electrode to which the label is attached with respect to the second direction after determining the unit electrode to which the label is attached and the predetermined number of unit electrodes trailing the unit electrode to which the label is attached to be a portion of the electrode sheet in which a defect is present.

According to an embodiment, the position shifted by the shift interval may be a position preceding the defect by the shift interval with respect to the first direction, and the removing of the portion of the electrode sheet in which the defect is present may involve removing a unit electrode to which the label is attached and a predetermined number of unit electrodes preceding the unit electrode to which the label is attached with respect to the second direction after determining the unit electrode to which the label is attached and the predetermined number of unit electrodes preceding the unit electrode to which the label is attached to be a portion of the electrode sheet in which a defect is present.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, the number of electrodes determined to be defective and removed can be reduced.

According to an embodiment of the present disclosure, defective electrodes can be prevented from advancing to subsequent processing steps.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing an apparatus for manufacturing an electrode according to an embodiment;

FIG. 2 is a view showing electrodes to be removed based on the locations of defects, labels, and cutting points;

FIG. 3 is a view showing a process, according to an embodiment, in which a label is attached to follow a defect, and the removal of a unit electrode trailing the unit electrode to which the label is attached;

FIG. 4 is a view showing a shift interval trailing a defect in an electrode sheet, according to an embodiment;

FIG. 5 is a view showing an appropriate shift interval depending on the size of a unit electrode, according to an embodiment;

FIG. 6 is a view showing a process, according to an embodiment, in which a label is attached to precede a defect, and the removal of a unit electrode preceding the unit electrode to which the label is attached;

FIG. 7 is a view showing a shift interval preceding a defect in an electrode sheet, according to an embodiment;

FIG. 8 is a view showing each step of a method for manufacturing an electrode according to an embodiment;

FIG. 9 is a view showing detailed steps of a step of attaching a label indicating a defect, according to an embodiment; and

FIG. 10 is a view showing detailed steps of a step of removing an electrode sheet, according to an embodiment.

### DETAILED DESCRIPTION

Hereinafter, the present disclosure will be described in detail with reference to the accompanying drawings. However, the following description is for illustrative purposes only, and the present disclosure is not intended to be limited to the specific embodiments exemplarily described.

Hereinafter, with reference to the accompanying drawings, an embodiment of the present disclosure will be described in detail.

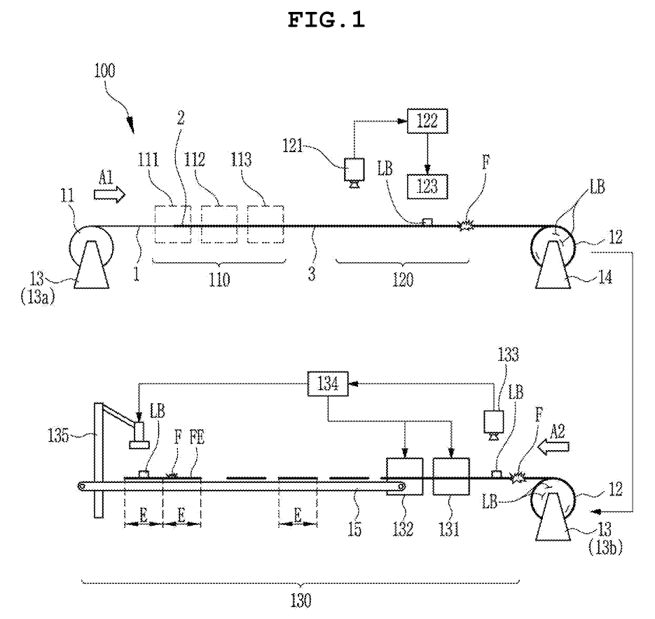

FIG. 1 is a view showing an apparatus 100 for manufacturing an electrode according to an embodiment.

The overall electrode manufacturing process will be described. The electrode manufacturing process may comprise a process of manufacturing an electrode sheet 3 by coating active material onto a current collector 1, drying, and pressing to form an electrode mixture layer 2, and a notching and cutting process of creating a tab on the electrode sheet 3 and separating the electrode sheet 3 into individual unit electrodes UEs.

The overall process for manufacturing the electrode sheet 3 will be described. A first unwinder 13a may unwind a current collector roll 11 in which the current collector 1 is wound. The current collector 1 may travel in a first direction A1 and pass through a coater 111. The coater 111 may coat the current collector 1 with active material to form the mixture layer 2. The mixture layer 2 may comprise either a negative electrode active material or a positive electrode active material. The mixture layer 2 coated on the current collector 1 may be dried as the mixture layer 2 passes through a dryer 112. The dried mixture layer 2 on the current collector 1 may be pressed while passing through a main roller 113 to increase the density of the mixture layer 2. When the current collector 1 passes through the coater 111, the dryer 112, and the main roller 113, an electrode sheet 3 may be produced. The electrode sheet 3 traveling in the first direction A1 may be wound by a rewinder 14 to form an electrode roll 12.

The overall notching and cutting process will be described. The electrode roll 12 may be transferred to a second unwinder 13b. The second unwinder 13b may unwind the electrode roll 12 and convey the electrode sheet 3 in a second direction A2. Since the second direction A2 is the direction in which the wound electrode sheet 3 is unwound, the second direction A2 may be considered opposite to the first direction A1. The first direction A1 and the second direction A2 do not refer to the left-right or up-down direction in the drawings. To be specific, the first direction A1 refers to the direction in which the electrode sheet 3 is wound onto the electrode roll 12, and the second direction A2 refers to the direction in which the electrode sheet 3 is unwound from the electrode roll 12. The electrode sheet 3 traveling in the second direction A2 may pass through a notcher 131 where a tab is created. The notcher 131 may use a die to remove a portion of the electrode sheet 3 while leaving a portion of the current collector 1 in the shape of a tab. The electrode sheet 3 with the tab created may then pass through a cutter 132 and be separated into unit electrodes UEs. The cutter 132 may cut the electrode sheet 3 according to a predetermined size E of the unit electrode UE. The cut and separated unit electrodes UEs may be conveyed by a transport system 15, such as a conveyor.

The apparatus 100 for manufacturing an electrode according to an embodiment may sense a defect F in the process of manufacturing the electrode sheet 3 and indicate the defect F with a label LB, and in the notching process, detect the label LB to remove a faulty F electrode sheet 3. The apparatus 100 for manufacturing an electrode may comprise: a defect inspection line 120 that senses a defect F in an electrode sheet 3 traveling in the first direction A1 and attaches a label LB to indicate the defect F on the electrode sheet 3; the rewinder 14 that rewinds the electrode sheet 3 having passed through the defect inspection line 120 to produce an electrode roll 12; the unwinder 13 that unwinds the electrode roll 12 and causes the electrode sheet 3 to travel in a second direction A2; and a defect removal line 130 that senses the label LB attached to the electrode sheet 3 output from the unwinder 13 and removes the electrode sheet 3 in which the defect F is present. The position at which the label LB indicating the defect F is attached may be a position shifted from the defect F by a shift interval based on the first direction A1.

The defect inspection line 120 may be installed on an electrode sheet 3 manufacturing line 110. The electrode sheet 3 manufacturing line 110 may comprise one or more of the coater 111, the dryer 112, and the main roller 113. The defect inspection line 120 may be installed between the equipment for manufacturing the electrode sheet 3, such as the coater 111, the dryer 112, and the main roller 113, and the rewinder 14. The defect inspection line 120 may sense defects F present in the electrode sheet 3 and attach labels LB indicating the defects F to the electrode sheet 3 before the electrode sheet 3 is input to the rewinder 14. The electrode sheet 3 with the labels LB attached may be wound by the first unwinder 13a to form an electrode roll 12 with the labels LB attached.

The defect inspection line 120 may comprise: a defect sensor 121 that captures images of the electrode sheet 3; a labeler 123 that attaches labels LB to the electrode sheet 3; and a first controller 122 that analyzes the images captured by the defect sensor 121 to determine whether defects F are present in the electrode sheet 3 and controls the labeler 123 to attach labels LB to the electrode sheet 3.

The defect sensor 121 may comprise a sensor for sensing defects F in the electrode sheet 3. The defect sensor 121 may comprise a camera, a distance sensor, an ultrasonic sensor, and various other sensors. The defect sensor 121 may transmit data generated by sensing the electrode sheet 3 to the first controller 122. The defect sensor 121 may capture the electrode sheet 3 to generate images. The images generated by the defect sensor 121 may be provided to the first controller 122. The defect sensor 121 may be positioned between the main roller 113 and the rewinder 14 in the process of manufacturing the electrode sheet 3.

The labeler 123 may attach labels LB to the electrode sheet 3. The labeler 123 may attach labels LB to the electrode sheet 3 based on control by the first controller 122. The labeler 123 may comprise a motor, a roller, a gear, and other mechanical components in order to receive a label sheet, separate labels LB from the label sheet, and attach the labels LB to designated positions. Since the labeler 123 performs an operation of physically attaching the labels LB to the electrode sheet 3, there is a limitation in that the labeler 123 cannot attach the labels LB continuously. The labeler 123 receives a signal to attach a label LB, performs an operation of attaching the label LB, and outputs a signal indicating completion of the label attachment, after which a predetermined minimum time is required before the labeler 123 is ready to attach a next label LB. Because the electrode sheet 3 travels during the minimum time, a minimum labeling interval occurs in which continuous attachment of labels LB is not possible. The labeler 123 can attach only one label LB for each minimum labeling interval. The labeler 123 is able to attach a next label LB only after the minimum labeling interval has elapsed.

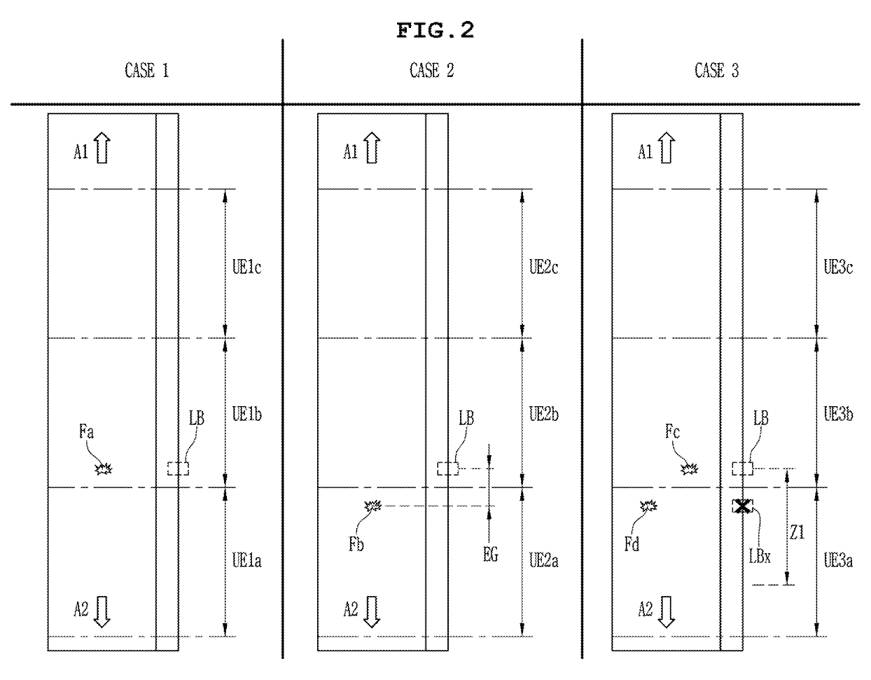

The labeler 123 may fail to attach a label LB at a desired position due to errors in mechanical operations or the like. For example, although a label LB is to be attached at the position of a defect F, the label LB may be attached at a position preceding the defect F or at a position trailing the defect F. In such an operation process of the labeler 123, a gap between the defect F and the label LB may be referred to as an error gap EG shown in FIG. 2. The size of the error gap EG may vary depending on the labeler 123. In case that a cutting point at which the electrode sheet 3 is cut in a notching and cutting process is located between the defect F and the label LB, a unit electrode containing the defect F and a unit electrode to which the label LB is attached may be different from each other.

The first controller 122 may analyze data received from the defect sensor 121 to determine whether a defect F is present in the electrode sheet 3 and to recognize a position of the defect F. The first controller 122 may control the labeler 123 to attach a label LB to the electrode sheet 3 in order to indicate the defect F.

The first controller 122 may comprise a processor and a memory communicatively connected to the processor to transmit and receive data. The processor may comprise a CPU, a GPU, an ASIC, or other semiconductor chips capable of information processing. The memory may comprise volatile or non-volatile memory, a hard disk, a magnetic tape, storage, and the like, and may store program code written to perform the steps of a method for manufacturing an electrode according to an embodiment. The processor may read and execute the program code stored in the memory to perform the method for manufacturing an electrode according to an embodiment. The first controller 122 may comprise a PC, a PLC, a tablet PC, a server computer, a process control system, or other computer devices.

The electrode sheet 3 that has passed through the defect inspection line 120 may be in a state in which labels LB indicating defects F are attached. The rewinder 14 may rewind the electrode sheet 3 that has passed through the defect inspection line 120 to produce an electrode roll 12. The electrode roll 12 produced by the rewinder 14 may be separated from the rewinder 14 and transferred to the second unwinder 13b.

The second unwinder 13b may unwind the electrode roll 12 and supply the electrode sheet 3 with labels LB attached to the defect removal line 130. At this time, a traveling direction in which the electrode sheet 3 is supplied to the defect removal line 130 may be the second direction A2.

The defect removal line 130 may comprise: a label sensor 133 that senses labels LB attached to the electrode sheet 3 traveling in the second direction A2 from the unwinder 13; the notcher 131 that performs notching to create tabs on the electrode sheet 3; the cutter 132 that cuts the electrode sheet 3 to separate the electrode sheet 3 into unit electrodes UE; and a second controller 134 that controls the notcher 131 so as not to perform notching on a unit electrode UE to which a label LB sensed by the label sensor 133 is attached and on a predetermined number of consecutive unit electrodes UE in the second direction A2, and controls the cutter 132 so as not to separate the unit electrode UE to which the label LB is attached and the predetermined number of consecutive unit electrodes UE. In addition, the second controller 134 may control the notcher 131 to perform notching to create tabs on the electrode sheet 3 where no defect F is present, and may control the cutter 132 to cut the notched electrode sheet 3 at predetermined intervals to separate the electrode sheet 3 into unit electrodes UE.

The label sensor 133 may sense labels LB attached to the electrode sheet 3. The label sensor 133 may sense the labels LB attached to the electrode sheet 3 and transmit positions of the labels LB to the second controller 134. The label sensor 133 may comprise various sensors such as a distance sensor, an optical sensor, a camera, or an ultrasonic sensor. The label sensor 133 may be positioned adjacent to the second unwinder 13b. The label sensor 133 may be positioned between the second unwinder 13b and the notcher 131 to sense the presence of labels LB before the electrode sheet 3 output from the second unwinder 13b enters the notcher 131. The label sensor 133 and the notcher 131 may be spaced apart by a distance greater than the size E (the total length) of a unit electrode UE to which a label LB is attached and a predetermined number of consecutive unit electrodes UE immediately following or preceding the unit electrode with the label LB attached.

The notcher 131 may perform notching to remove a portion of the electrode sheet 3 and create a tab. The notcher 131 may comprise mechanical elements such as a mold, a press, or the like for performing the notching. The notcher 131 may create a tab on the electrode sheet 3 by removing a portion of the current collector 1. The notcher 131 operates under the control of the second controller 134 and may not perform notching on a unit electrode UE to which a label LB is attached and on a predetermined number of consecutive unit electrodes UE from the labeled unit electrode.

The cutter 132 may cut the notched electrode sheet 3 to separate the sheet 3 into unit electrodes UE. The cutter 132 may comprise mechanical elements such as a blade, a driving unit for the blade, or the like. The cutter 132 may cut the electrode sheet 3 according to the size E of the unit electrode UE under the control of the second controller 134. By cutting the electrode sheet 3 according to the predetermined size E of the unit electrode UE, a plurality of unit electrodes UE may be separated from each other.

The cutter 132 may, under the control of the second controller 134, not cut a unit electrode UE to which a label LB is attached and a predetermined number of consecutive unit electrodes UE from the labeled unit electrode. An electrode sheet 3 containing a defect F may be referred to as a faulty electrode FE. The faulty electrode FE comprises a labeled unit electrode UE and a predetermined number of consecutive unit electrodes UE from the labeled unit electrode. The labeled unit electrode UE and a single unit electrode UE immediately following or preceding the labeled unit electrode UE may remain connected to each other while passing through the notcher 131 and the cutter 132 without being separated.

The second controller 134 may analyze data received from the label sensor 133 to recognize the position of a label LB. The second controller 134 may match the position of the label LB with the positions of the unit electrodes UE to identify which unit electrode UE has the label LB attached. The electrode sheet 3 has a continuous form, and the size E of each unit electrode UE for separating the electrode sheet 3 is predetermined. Once an initial cutting point is determined on the electrode sheet 3, subsequent cutting points may be repeated at intervals corresponding to the size E of the unit electrode UE. If the position of the label LB on the electrode sheet 3 is known, it is possible to determine which unit electrode UE has the label LB attached.

The second controller 134 may control the notcher 131 and the cutter 132 to create tabs and perform cutting on an electrode sheet 3 where a label LB is not attached, indicating that no defect F is present, to produce unit electrodes UE.

The second controller 134 may designate a labeled unit electrode UE and a predetermined number of consecutive unit electrodes UE from the labeled unit electrode UE as targets for removal. The second controller 134 may control the notcher 131 and the cutter 132 so that no notching is performed on the labeled unit electrode UE and the predetermined number of consecutive unit electrodes UE, and so that the labeled unit electrode UE and the predetermined number of consecutive unit electrodes UE are not separated from each other.

The second controller 134 may comprise a processor and a memory communicatively connected to the processor to transmit and receive data. The processor may comprise a CPU, a GPU, an ASIC, or other semiconductor chips capable of information processing. The memory may comprise volatile or non-volatile memory, a hard disk, a magnetic tape, storage, and the like, and may store program code written to perform the steps of a method for manufacturing an electrode according to an embodiment. The processor may read and execute the program code stored in the memory to perform the method for manufacturing an electrode according to an embodiment. The first controller 122 may comprise a PC, a PLC, a tablet PC, a server computer, a process control system, or other computer devices. The first controller 122 and the second controller 134 may be implemented as a single computer device.

FIG. 2 is a view showing electrodes to be removed based on the locations of defects F, labels LB, and cutting points. FIGS. 1 and 2 are referred to together.

Since the electrode sheet 3 travels at a high speed (for example, 100 m/min) in the first direction A1, it may be difficult for the labeler 123 to accurately attach a label LB at a position where a defect F is present. Due to an error gap EG of the labeler 123 itself, the labeler 123 may have difficulty accurately attaching a label LB to the position of a defect F. The labeler 123 cannot attach a plurality of labels LB within a section corresponding to a minimum labeling interval. In addition, during a process in which notching and cutting are performed while the electrode sheet 3 travels in a second direction A2, the label LB may fail to indicate the defect F. The position of a cutting point at which the cutter 132 cuts the electrode sheet 3 is determined as a position spaced apart by the size E of a unit electrode UE from an initial cutting point of the electrode sheet 3. Accordingly, the cutting point may be located between the defect F and the label LB. Alternatively, the cutting point may be positioned for the cutter 132 to cut through the defect F, so that the defect F may be present in two consecutive unit electrodes UE.

As in CASE 1 of FIG. 2, the labeler 123 may accurately attach a label LB to the position of a defect Fa. When a portion of the electrode sheet 3 corresponding to a unit electrode UE1b to which the label LB is attached is removed in the notching process, the defect F can be removed. Thus, the unit electrode UE1b to which the label LB is attached is removed, and unit electrodes UE1a and UE1c to which no label LB is attached may be used for battery cell manufacturing. However, CASE 1 is an ideal case.

As in CASE 2 of FIG. 2, the labeler 123 may fail to accurately attach a label LB to the position of a defect Fb. A positional difference between the defect Fb and the label LB may occur due to a temporary change in the traveling speed of the electrode sheet 3 or due to an error gap EG of the labeler 123. The label LB may be attached at a position preceding or trailing the defect Fb in the first direction A1. In case that a cutting point is located between the label LB and the defect Fb, a unit electrode UE2b to which the label LB is attached and a unit electrode UE2a in which the defect F is present may be different. In this case, the unit electrode UE2b to which the label LB is attached is a normal electrode without a defect but is removed, while the unit electrode UE2c in which the defect F is present may be used for manufacturing a battery cell, thereby causing a problem.

As in CASE 3 of FIG. 2, the labeler 123 attaches a label LB to the position of a first defect Fc, but a second defect Fd may be present close to the first defect Fc. The second defect Fd may be located within a first zone Z1 corresponding to a minimum labeling interval of the labeler 123. Even if the first controller 122 senses the second defect Fd, a label LBx indicating the second defect Fd may not be attached due to limitations of the labeler 123. In this case, when the electrode sheet 3 travels in the second direction A2 along the defect removal line 130, the defect Fd precedes the label LB. That is, the defect Fd passes through the label sensor 133 first, and the label LB passes through the label sensor 133 later. As a result, a unit electrode UE3b to which the label LB is attached is removed, while a unit electrode UE3a in which the defect F is present but to which no label LB is attached may be used for manufacturing a battery cell, thereby causing a problem.

A defect F may comprise a spot defect having a short length of defect and a line defect having a long length of defect. In the case of a line defect, the defect may be formed across a plurality of unit electrodes.

To prevent the problems as in CASES 2 and 3 and to remove all line defects F, a method of removing three unit electrodes UE may be used. The method of removing three unit electrodes UE involves removing a unit electrode UE to which a label LB is attached, one consecutive unit electrode UE preceding the unit electrode UE to which the label LB is attached, and one consecutive unit electrode UE trailing the unit electrode UE to which the label LB is attached. For example, in CASE 1, three unit electrodes UE1a, UE1b, and UE1c may be removed; in CASE 2, three unit electrodes UE2a, UE2b, and UE2c may be removed; and in CASE 3, three unit electrodes UE3a, UE3b, and UE3c may be removed. In CASE 1, two normal unit electrodes UE1a and UE1c may be removed; in CASE 2, two normal unit electrodes UE2b and UE2c may be removed; and in CASE 3, one normal unit electrode UE3c may be removed. When three unit electrodes UE are removed, normal electrodes are removed as well, which causes a problem in that the electrode manufacturing yield is reduced.

According to an embodiment, the apparatus 100 and the method for manufacturing an electrode allow a label LB to be attached at a position shifted by a shift interval and remove two unit electrodes. Thus, it is possible to prevent a unit electrode in which a defect F is present from being used for manufacturing a battery cell, and to improve electrode manufacturing yield by removing only a minimum number of unit electrodes.

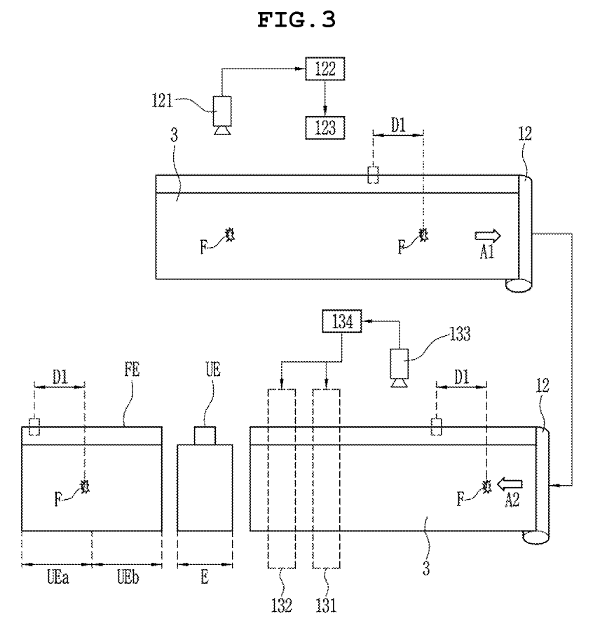

FIG. 3 is a view illustrating a process of attaching a label LB so as to trail a defect F and removing a unit electrode UE trailing the unit electrode UE to which the label LB is attached, according to an embodiment. FIGS. 1 and 3 are referred to together.

According to an embodiment, in the defect inspection line 120 of the apparatus 100 for manufacturing an electrode, a position at which a label LB is attached is a position shifted by a shift interval D1. The position shifted by the shift interval D1 may be a position trailing the defect F by the shift interval D1 with respect to the first direction A1.

The attachment of a label LB so as to trail a defect F will be described. Attaching the label LB so as to trail the defect F means that the label LB is positioned behind the defect F with respect to the first direction A1. Based on the first direction A1, the defect sensor 121 and the first controller 122 recognize a defect F, and after the defect F passes the labeler 123, the labeler 123 may attach a label LB to the electrode sheet 3. By attaching the label LB so as to trail the defect F in this manner, when the electrode roll 12 to which the label LB is attached is transferred to the notching process and the second rewinder 14 unwinds the electrode roll 12, the electrode sheet 3 can enter the notcher 131 such that the label LB precedes the defect F. The label sensor 133 detects the label LB attached to the electrode sheet 3 traveling in the second direction A2, after which the defect F follows. In other words, on the defect removal line 130, no defect F precedes the label LB.

On the defect removal line 130, a unit electrode UE to which the label LB is attached and a predetermined number of unit electrodes UE trailing the unit electrode UE to which the label LB is attached with respect to the second direction A2 may be determined as a faulty electrode FE in which a defect F is present, and removed. The predetermined number may be one. That is, on the defect inspection line 120, a label LB is attached so as to trail a defect F by a shift interval D1, and on the defect removal line 130, a total of two unit electrodes, a unit electrode UEa to which the label LB is attached and one consecutive unit electrode UEb trailing the labeled unit electrode UEa, may be removed. By using this method, only two unit electrodes need to be removed instead of three, thereby minimizing the removal rate.

The second controller 134 may prevent notching and cutting processes from being performed on the unit electrode UEa to which the label LB is attached and on one consecutive unit electrode UEb trailing the labeled unit electrode UEa. The second controller 134 may control a picker 135 to pick up and remove the faulty electrode FE in a consecutive state. The picker 135 may pick up the faulty electrode FE and transport the faulty electrode FE to a discharge location.

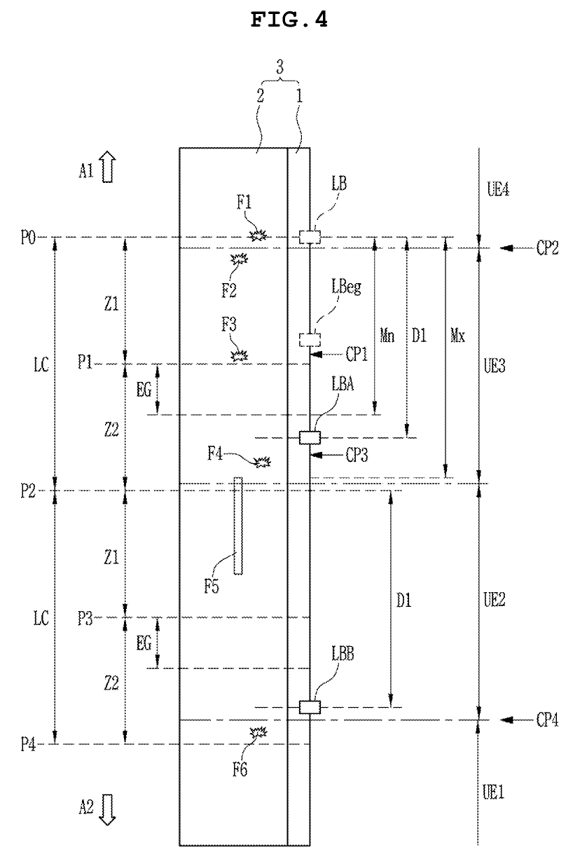

FIG. 4 is a view illustrating a shift interval D1 trailing a defect F on the electrode sheet 3 according to an embodiment. FIGS. 1, 3, and 4 are referred to together.

The shift interval D1 may be set within a range where a minimum value Mn is equal to the length of a first zone Z1, which corresponds to the minimum labeling interval of the labeler 123, plus an error gap EG during label attachment by the labeler 123, and a maximum value Mx is equal to the size E of a unit electrode UE.

The shift interval D1 may be determined between the minimum value Mn and the maximum value Mx. The minimum value Mn of the shift interval D1 may be the length of the first zone Z1 corresponding to the minimum labeling interval plus the error gap EG of the labeler 123 during label attachment. The maximum value Mx of the shift interval D1 may be set as the size E of the unit electrode UE.

In case that the shift interval D1 is smaller than the size of the first zone Z1, there is a possibility that, due to the attachment error of the labeler 123, a defect F may precede a label LB in the notching process. For example, when the shift interval D1 is determined as the length of the first zone Z1, a label LBeg1 may be attached at a position preceding an end point P1 of the first zone Z1 due to the error gap EG. In this case, a third defect F3 adjacent to the end point P1 of the first zone Z1 may precede the label LBeg1. In case that a cutting point CP1 is located between the third defect F3 and the label LBeg1, the third defect F3 and the label LBeg1 may be positioned on different unit electrodes UE. Since the unit electrode UE in which the third defect F3 is located precedes the unit electrode UE to which the label LBeg1 is attached, the unit electrode UE containing the third defect F3 may be determined as a normal electrode and could potentially be used in battery cell manufacturing. Setting the minimum value Mn of the shift interval D1 to a size obtained by adding the error gap EG to the size of the first zone Z1 may prevent such a problem. This is because, when the shift interval D1 is equal to or greater than the size of the first zone Z1 plus the error gap EG, the label LB is prevented from being attached within the first zone Z1 even if the label LB is attached earlier than a desired position due to the error gap EG.

In case that the shift interval D1 is larger than the size E of a unit electrode UE, the distance between the defect F and the label LB becomes too large, such that one unit electrode UE may be positioned between the defect F and the label LB. In this case, even when two unit electrodes UE are removed based on the label LB, the defect F may be located in a third unit electrode UE and be transferred to a subsequent process. Thus, the maximum value Mx of the shift interval D1 may be set to be smaller than the size E of the unit electrode UE.

There is a possibility that a plurality of spot defects F and a plurality of line defects F are consecutively present in close proximity on the electrode sheet 3. For such a case, a method of attaching labels LB and a method of removing electrodes will be described.

In order to attach a plurality of labels LB, the first controller 122 sets a first zone Z1, a second zone Z2, and a labeling cycle interval LC, and may perform labeling differently depending on whether a defect F is located in the first zone Z1 or the second zone Z2.

The first zone Z1 has a length corresponding to a minimum labeling interval of the labeler 123. A start point of the first zone Z1 may be a position P0 of a first defect F. An end point of the first zone Z1 may be a position P1 trailing the position P0 of the first defect F by a length corresponding to the minimum labeling interval in the first direction A1. A start point of the second zone Z2 may be the end point P1 of the first zone Z1. An end point of the second zone Z2 may be a position P2 trailing the end point P1 of the first zone Z1 by a predetermined distance. The second zone Z2 corresponds to a remaining portion of a labeling cycle interval LC excluding the first zone Z1. That is, the first zone Z1 and the second zone Z2 together may constitute the labeling cycle interval LC.

The labeling cycle interval LC is an interval at which labels LB can be stably attached by considering the traveling speed of the electrode sheet 3 when two labels LB are consecutively attached to the electrode sheet 3. The labeling cycle interval LC is a value determined by a user. The labeling cycle interval LC may be set to be greater than the size of the first zone Z1, greater than a length obtained by adding an error gap EG to the size of the first zone Z1, and greater than the shift interval D1. The labeling cycle interval LC may be determined to be smaller than the size of two unit electrodes UE. The labeling cycle interval LC may be set to be as small as possible within an allowable range. By setting the labeling cycle interval LC to be small, labels LB indicating defects F may be attached at narrow intervals, thereby minimizing the number of unit electrodes UE corresponding to faulty electrodes FE.

The first zone Z1 is a value determined according to the specifications of the labeler 123, and the size of the second zone Z2 may vary depending on the labeling cycle interval LC.

The first controller 122 may analyze an image received from the defect sensor 121 to recognize a position of a current defect F on the electrode sheet 3, may determine whether the current defect F is comprised in a previously set first zone Z1 or second zone Z2, and, when the current defect F is not comprised in the previously set first zone Z1 or second zone Z2, may control the labeler 123 to attach a label LB at a position shifted by a shift interval D1 from the position of the current defect F, and may set the first zone Z1 and the second zone Z2 starting from the position of the current defect F. In this case, the position shifted by the shift interval D1 may be a position trailing the defect F by the shift interval D1 with respect to the first direction A1.

It is assumed that only a first defect F1 exists on the electrode sheet 3. The first controller 122 may recognize the position of the first defect F1 present on the electrode sheet 3. It is assumed that any defect (not shown) preceding the first defect F1 is located at a distance greater than the labeling cycle interval LC from the first defect F1. The first controller 122 may determine that the first defect F1 is not comprised in the first zone Z1 or the second zone Z2 previously set from the position of the preceding defect (not shown). The first controller 122 may control the labeler 123 to attach a first label LBA to indicate the first defect F1. In this case, the first label LBA may be attached at a position trailing the first defect F1 by a shift interval D1 in the first direction A1. The first controller 122 may also set the first zone Z1 and the second zone Z2 based on the position of the first defect F1.

On the defect removal line 130, the electrode sheet 3 travels in the second direction A2, with the first label LBA preceding and the first defect F1 following. On the defect removal line 130, the unit electrode UE3 to which the label LBA is attached, as well as one consecutive unit electrode UE4 trailing the labeled unit electrode UE3, may be removed. Even if a cutting point CP2 is located between the first label LBA and the first defect F1, the defect removal line 130 removes the unit electrode UE3 to which the first label LBA is attached and one consecutive unit electrode UE4 trailing the unit electrode UE3, and thus the first defect F1 may be removed.

It is assumed that a first defect F1, a second defect F2, a third defect F3, and a fourth defect F4 are present on the electrode sheet 3.

In case that a current defect F is comprised in a previously set first zone Z1 or second zone Z2, the first controller 122 may determine whether the current defect F is located within the first zone Z1, and when the current defect F is within the first zone Z1, no label LB is attached. When the current defect F is not within the first zone Z1, the first controller 122 may control the labeler 123 to attach a label LB at a position shifted by the shift interval D1 from the end point of the second zone Z2, and may further set a first zone Z1 and a second zone Z2 starting from the end point of the second zone Z2. In this case, the position shifted by the shift interval D1 may be a position trailing by the shift interval D1 in the first direction A1.

The first controller 122 may recognize the first defect F1, attach the first label LBA as described above, and set the first zone Z1 and the second zone Z2. The first controller 122 may then recognize the second defect F2 and determine whether the second defect F2 is comprised in the previously set first zone Z1 or second zone Z2. Since the second defect F2 is located within the first zone Z1, the first controller 122 may not attach a label LB. Because the second defect F2 is within the previously set first zone Z1, the first controller 122 does not reset the first zone Z1 and the second zone Z2.

The third defect F3 may be determined in the same way as the second defect F2. Since the third defect F3 is also located within the first zone Z1 set based on the first defect F1, the first controller 122 may not attach a label LB.

The first controller 122 may recognize the fourth defect F4 and then determine whether the fourth defect F4 is comprised in the previously set first zone Z1 or second zone Z2. The fourth defect F4 is not located in the first zone Z1. That is, the fourth defect F4 is located in the second zone Z2. When the fourth defect F4 located in the second zone Z2 is positioned after the first label LBA, a problem may occur in which the fourth defect F4 precedes the first label LBA on the defect removal line 130. That is, when the cutting point CP3 is located between the fourth defect F4 and the first label LBA, the unit electrode UE to which the first label LBA is attached and the unit electrode UE in which the fourth defect F4 is located may be different. Thus, in order to indicate a defect F present in the second zone Z2, the first controller 122 may additionally attach a second label LBB at a position following the end point P0 of the second zone Z2 by the shift interval D1. In summary, defects F comprised in the first zone Z1 starting from the first defect F may be indicated by the first label LBA that follows the first defect F by a shift interval D1, and defects F comprised in the second zone Z2 may be indicated by the second label LBB that follows an end point P2 of the second zone Z2 by the shift interval D1. In addition, since the fourth defect F4 existed in the second zone Z2, the first controller 122 may set a new first zone Z1 and a new second zone Z2 starting from the end point P2 of the previous second zone Z2. The new first zone Z1 has a start point P2 and an end point P3, and the new second zone Z2 has a start point P3 and an end point P4.

On the defect removal line 130, the electrode sheet 3 travels in the second direction A2, such that the second label LBB precedes and the fourth defect F4 follows. In addition, the first label LBA precedes, and the third defect F3, the second defect F2, and the first defect F1 sequentially follow. Accordingly, the defect removal line 130 may remove the unit electrodes UE2 and UE3 to which the labels LBA and LBB are attached, and one unit electrode UE4 that continuously follows the unit electrode UE3 to which the label LBA is attached.

It is assumed that first to sixth defects F1 to F6 are present in the electrode sheet 3.

The first controller 122 may attach the first label LBA and the second label LBB to the first defect F1 through the fourth defect F4 as described above. In addition, since the fourth defect F4 existed in the second zone Z2, the first controller 122 may set a new first zone Z1 and a new second zone Z2 starting from the end point P2 of the previous second zone Z2.

The first controller 122 may recognize the fifth defect F5 and determine that the fifth defect F5 is a line defect F. Since the fifth defect F5 is located across the existing second zone Z2 from P1 to P2 and the newly set first zone Z1 from P2 to P3, the first controller 122 may determine to attach a label LB at a position following the end point of the second zone Z2 by the shift interval D1 in order to indicate a defect F located in the second zone Z2. However, since the second label LBB has already been determined to be attached due to the fourth defect F4, it is not necessary to attach a label LB to indicate the portion corresponding to the existing second zone Z2 from the fifth defect F5. The first controller 122 may determine whether the fifth defect F5 is comprised in the newly set first zone Z1 or second zone Z2. Since the fifth defect F5 is comprised only in the newly set first zone Z1, the first controller 122 may not attach a label LB for indicating a defect F present in the newly set first zone Z1.

The first controller 122 may recognize the sixth defect F6 and determine whether the sixth defect F6 is comprised in the newly set first zone Z1 or second zone Z2. Since the sixth defect F6 is comprised in the newly set second zone Z2 from P3 to P4, the first controller 122 may determine to attach a third label (not shown) at a position following the end point P4 of the newly set second zone Z2 by a shift interval D1. When the cutting point CP4 is located between the second label LBB and the sixth defect F6, if the third label (not shown) is not attached, the unit electrode UE1 in which the sixth defect F6 is located may not be removed. Thus, when a defect F exists in the newly set second zone Z2, a label LB may be additionally attached at a position following the end point P4 of the newly set second zone Z2 by the shift interval D1.

On the defect removal line 130, the electrode sheet 3 travels in the second direction A2, such that the third label (not shown) precedes and the sixth defect F6 follows. In addition, the second label LBB precedes, and the fifth defect F5 and the fourth defect F4 sequentially follow. Furthermore, the first label LBA precedes, and the third defect F3, the second defect F2, and the first defect F1 sequentially follow. Accordingly, the defect removal line 130 may remove the unit electrodes UE1, UE2, and UE3 to which the labels (not shown, LBB, LBA) are attached, and one unit electrode UE4 that continuously follows the unit electrode to which the label LBA is attached.

As described above, the first controller 122 may attach or not attach a label LB depending on whether the position of a defect F is located in the first zone Z1 or the second zone Z2. When an electrode roll 12 with labels LB indicating defects F in this manner is supplied to the defect removal line 130, the electrode sheet 3 in which a defect F may exist can be removed under the control of the second controller 134.

In case that a label LB exists on the electrode sheet 3, the second controller 134 may control the notcher 131 so as not to perform notching on a predetermined number of consecutive unit electrodes UE starting from and comprising the unit electrode UE to which the label LB is attached, with respect to the second direction A2, and may control the cutter 132 so as not to separate a predetermined number of consecutive unit electrodes UE starting from and comprising the unit electrode UE to which the label LB is attached, with respect to the second direction A2. When the portion of the electrode sheet 3 corresponding to the unit electrode UE to which the label LB is attached and the predetermined number of consecutive unit electrodes UE has passed, the second controller 134 may control the notcher 131 to perform notching to create a tab on the electrode sheet 3 in which no defect F exists, and may control the cutter 132 to cut at a predetermined interval to separate the notched electrode sheet 3 into unit electrodes UE. In this case, the second controller 134 may prevent notching and cutting from being performed on the unit electrode UE to which the label LB is attached and one consecutive unit electrode UE following the unit electrode UE with the label LB attached with respect to the second direction A2.

As described above, the operation of the defect removal line 130 will be described assuming that the first defect F1 to the fifth defect F5 exist.

In case that a label LB exists on the electrode sheet 3, the second controller 134 may control the notcher 131 so as not to perform notching on a predetermined number of consecutive unit electrodes UE starting from and comprising the unit electrode UE to which the label LB is attached, with respect to the second direction A2, and may control the cutter 132 so as not to separate the predetermined number of consecutive unit electrodes UE starting from and comprising the unit electrode UE to which the label LB is attached, with respect to the second direction A2. When the portion of the electrode sheet 3 corresponding to the unit electrode UE to which the label LB is attached and the predetermined number of consecutive unit electrodes UE has passed, the second controller 134 may control the notcher 131 to perform notching to create a tab on the electrode sheet 3, and may control the cutter 132 to cut at a predetermined interval to separate the notched electrode sheet 3 into unit electrodes UE. In this case, the second controller 134 may prevent notching and cutting from being performed on the unit electrode UE to which the label LB is attached and one consecutive unit electrode UE following the unit electrode UE with the label LB attached with respect to the second direction A2.

In addition, when the portion of the electrode sheet 3 corresponding to the unit electrode UE to which the label LB is attached and the predetermined number of consecutive unit electrodes UE has passed, the second controller 134 may control the picker 135 to remove a continuous portion of the electrode sheet 3 corresponding to the predetermined number of consecutive unit electrodes UE starting from and comprising the unit electrode UE to which the label LB is attached in the second direction A2.

The electrode sheet 3 passes through the label sensor 133 with the first label LBA indicating the first defect F1 through the third defect F3 and the second label LBB indicating the fourth defect F4 and the fifth defect F5 attached to the electrode sheet 3. The label sensor 133 senses the second label LBB, and the second controller 134 may recognize the position of the second label LBB. The second controller 134 may recognize which unit electrode UE the second label LBB is attached to by comparing the position of the second label LBB with the position of the cutting point. The second controller 134 may control the notcher 131 and the cutter 132 so as not to perform notching and cutting on the unit electrode UE2 to which the second label LBB is attached and one consecutive unit electrode UE3 trailing the unit electrode UE2. In this state, the cutter 132 may cut between the unit electrode UE1 without a defect F and the unit electrode UE2 to which the second label LBB is attached. The notcher 131 may not perform notching on the unit electrode UE2 to which the second label LBB is attached and one consecutive unit electrode UE3 trailing the unit electrode UE2.

Subsequently, the label sensor 133 senses the first label LBA, and the second controller 134 may recognize the position of the first label LBA. The second controller 134 may recognize which unit electrode UE the first label LBA is attached to by comparing the position of the first label LBA with the position of the cutting point. The second controller 134 may control the notcher 131 and the cutter 132 so as not to perform notching and cutting on the unit electrode UE3 to which the first label LBA is attached and one consecutive unit electrode UE4 trailing the unit electrode UE3. As a result, the three unit electrodes UE2, UE3, and UE4 may not be subjected to notching and cutting. The three unit electrodes UE2, UE3, and UE4 may pass through the notcher 131 and the cutter 132 while remaining connected to each other.

The second controller 134 may determine whether a predetermined number of unit electrodes UE have passed. When the second controller 134 determines that the unit electrode UE to which a label LB is attached and one consecutive unit electrode UE trailing the labeled unit electrode UE have all passed, the second controller 134 may control the notcher 131 and the cutter 132 to perform notching and cutting again. Accordingly, the unit electrode UE4 in which a defect F exists and the subsequent unit electrode UE in which no defect F exists (not shown) may be separated.

Due to the operations of the first controller 122 and the second controller 134 described above, even a defect F formed over a very long area exceeding the labeling cycle LC may be indicated by attaching multiple labels LB. In addition, since the attachment of labels LB is determined based on the labeling cycle interval LC, the first zone Z1, and the second zone Z2, only a minimum number of unit electrodes UE may be removed whether only one defect F exists or multiple consecutive defects F exist. In addition, unit electrodes UE in which defects F exist may not be transferred to the next process.

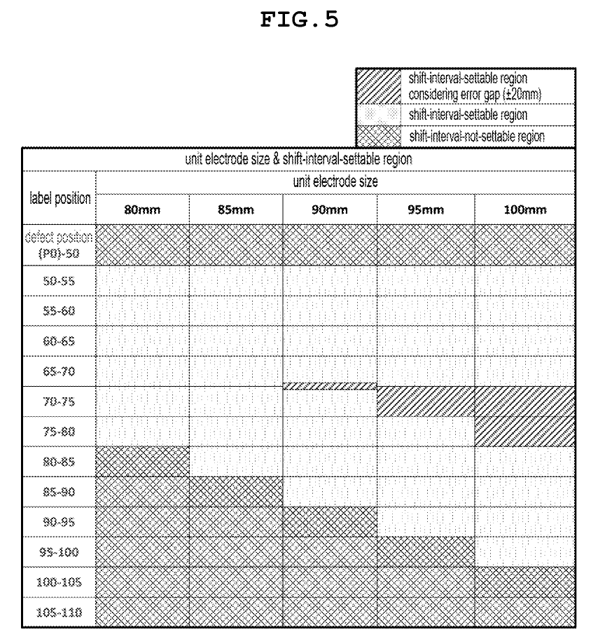

FIG. 5 is a view illustrating an appropriate shift interval D1 according to the size E of the unit electrode UE in an embodiment. Reference is made to FIG. 4 together. FIG. 5 illustrates a case in which the error gap EG of the labeler 123 is 20 mm and the minimum labeling interval of the labeler 123 is 50 mm.

The shift interval D1 may be determined between a minimum value Mn and a maximum value Mx. The minimum value Mn is fixed as the size of the first zone Z1 when the error gap EG is not considered. In FIG. 5, the range from the defect position P0 to a distance of 50 mm, which corresponds to the first zone Z1, is a shift-interval-not-settable region in which the shift interval D1 is not settable.

The maximum value Mx of the shift interval D1 is the size E of the unit electrode UE. Thus, when the shift interval D1 exceeds the size E of the unit electrode UE, the corresponding region is a shift-interval-not-settable region. For example, when the size E of the unit electrode UE is 90 mm, the shift interval D1 cannot exceed 90 mm. In FIG. 5, regions greater than the size E of the unit electrode UE are indicated as shift-interval-not-settable regions.

Therefore, the shift-interval-settable region is a range greater than the size of the first zone Z1 and smaller than the size E of the unit electrode UE. As the size E of the unit electrode UE increases, a range that can be determined as the shift interval D1 may increase.

A shift-interval-settable region considering the error gap EG (±20 mm) refers to a shift interval D1 that enables reliable removal of a defect F when the error gap EG of the labeler 123 is taken into account. In case that the error gap EG is ±20 mm and the size of the first zone Z1 is 50 mm, a shift-interval-settable region (70 mm) considering the error gap EG may exist when the size E of the unit electrode UE is 90 mm or greater. The larger the size E of the unit electrode UE, the wider the range of shift-interval-settable region considering the error gap EG can be.

Considering various sizes E of the unit electrode UE, an appropriate shift interval D1 may be 70 mm. In case that the shift interval D1 is set to 70 mm, there is a possibility of label LB attachment errors due to the error gap EG when the size E of the unit electrode UE is 80 mm or 85 mm, but the extent of the error is not significant. In addition, when the size E of the unit electrode UE is 90 mm or greater, even if a label LB attachment error occurs, a defect F may be reliably indicated. When the first controller 122 controls the labeler 123 with the shift interval D1 set to 70 mm, defects F may be reliably removed in the electrode manufacturing process even if the size E of the unit electrode UE changes to 80 mm or greater. A user may refer to a table showing the size E of the unit electrode UE and shift-interval-settable regions to determine a shift interval D1 that can be applied to unit electrodes UE of various sizes.

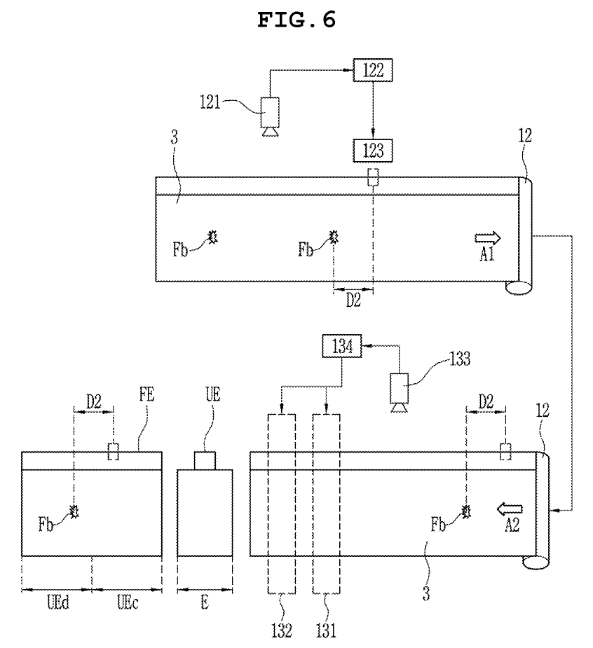

FIG. 6 is a view illustrating a process of attaching a label LB to precede a defect F and removing a unit electrode UE preceding the unit electrode UE to which the label LB is attached in an embodiment. Reference is made to FIGS. 1 and 3 together.

According to an embodiment, in the defect inspection line 120 of the apparatus 100 for manufacturing an electrode, the position where a label LB is attached is a position shifted by a shift interval D2. The position shifted by the shift interval D2 may be a position preceding a defect F by the shift interval D2 with respect to the first direction A1.

The attachment of a label LB to precede a defect F will be described. Attaching a label LB to precede a defect F means that the label LB precedes the defect F with respect to the first direction A1. Based on the first direction A1, the defect sensor 121 and the first controller 122 recognize the defect F, and before the defect F passes through the labeler 123, the labeler 123 may attach the label LB to the electrode sheet 3. When the label LB is attached to precede the defect F in this way, the electrode roll 12 with the label LB attached is conveyed to the notching process, and when the second rewinder 14 unwinds the electrode roll 12, the electrode sheet 3 may enter the notcher 131 such that the defect F precedes the label LB. After the defect F on the electrode sheet 3 traveling in the second direction A2 passes through the label sensor 133, the label sensor 133 recognizes the label LB. That is, in the defect removal line 130, the defect F precedes the label LB.

In the defect removal line 130, a unit electrode UE to which the label LB is attached and a predetermined number of unit electrodes UE preceding the labeled unit electrode UE in the second direction A2 may be determined as a portion of the electrode sheet 3 in which defects F exist and removed. The predetermined number may be one. That is, the defect inspection line 120 attaches a label LB to precede a defect F by the shift interval D2, and in the defect removal line 130, the unit electrode UE to which the label LB is attached and one consecutive unit electrode UE preceding the labeled unit electrode UE may be removed, for a total of two unit electrodes UE. Using this method, only two unit electrodes UE need to be removed instead of three, minimizing the removal rate.

The second controller 134 may not perform notching and cutting on the unit electrode UEc to which the label LB is attached and one consecutive unit electrode UEd preceding the labeled unit electrode UEc. The second controller 134 may control the picker 135 to pick up and remove the faulty electrode FE in a consecutive state. The picker 135 may pick up the faulty electrode FE and move the faulty electrode FE to a discharge location.

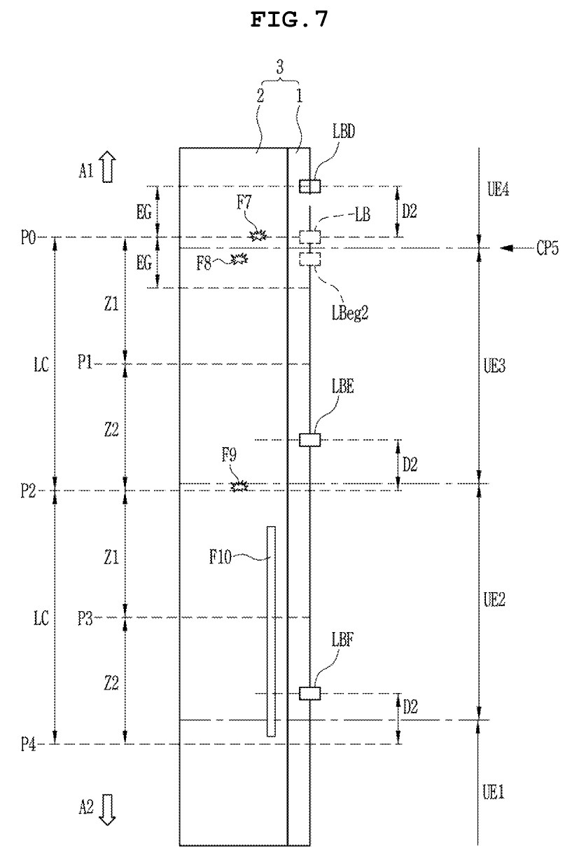

FIG. 7 is a view illustrating the shift interval D2 preceding a defect F on the electrode sheet 3 in an embodiment. Reference is made to FIGS. 1, 6, and 7 together.

The shift interval D2 may be set to the length of the error gap EG during label attachment by the labeler 123. In case that the label LB is attached to precede the defect F in the first direction A1, the length of the first zone Z1 corresponding to the minimum labeling interval of the labeler 123 may not be considered when setting the shift interval D2. When the labeler 123 described above attaches a label LB to follow a defect F, in the defect removal line 130, a labeled unit electrode UE and a consecutive unit electrode UE trailing the labeled unit electrode UE in the second direction A2 are removed together. Thus, in order to reliably remove defects F located in the first zone Z1, the shift interval D1 needed to be set so that the label LB precedes the defect F by a distance equal to the length of the first zone Z1 in the first direction A1. However, when the label LB is attached to precede the defect F in the first direction A1, a unit electrode UE with the label LB attached and a consecutive unit electrode UE preceding the labeled unit electrode UE in the second direction A2 are removed together in the defect removal line 130. Thus, a defect F comprised in the first zone Z1 may also be removed together. Accordingly, when the label LB is attached to precede the defect F in the first direction, the shift interval D2 may be set to the size of the error gap EG.

When the first controller 122 attempts to attach a label LB at the location of a seventh defect F7, due to the error gap EG of the labeler 123, a label LBeg2 may be attached at a position following the seventh defect F7. In this case, if the cutting point CP5 is located between the seventh defect F7 and label LBeg2, and the unit electrode UE3 with label LBeg2 attached and the consecutive unit electrode UE2 preceding the unit electrode UE3 with label LBeg2 attached in the second direction A2 are removed, the unit electrode UE4 containing the seventh defect F7 may not be removed. By setting the shift interval D2 to the size of the error gap EG, and attaching the label LB to precede the seventh defect F7 by the shift interval D2 in the first direction A1, even if the label LBD is attached slightly behind due to the error gap EG, as the unit electrode UE4 with label LBD attached and the consecutive unit electrode UE3 preceding the unit electrode UE4 in the second direction A2 are removed, the seventh defect F7 may be reliably removed.

On the electrode sheet 3, a plurality of spot defects and a plurality of line defects may occur consecutively in close proximity. In such cases, a method for attaching labels LB and a method for removing electrodes are described.

The first controller 122 may set the first zone Z1, the second zone Z2, and the labeling cycle interval LC, and determine whether to attach a label based on whether a defect F is located in the first zone Z1 or the second zone Z2. Since the first zone Z1, the second zone Z2, and the labeling cycle interval LC have been described with reference to FIG. 4, redundant explanation is omitted.

The first controller 122 may analyze images received from the defect sensor 121 to recognize the location of a current defect F on the electrode sheet 3, may determine whether the current defect F is comprised in the previously set first zone Z1 or second zone Z2, and in case that the current defect F is not comprised in the previously set first zone Z1 or second zone Z2, may control the labeler 123 to attach a label LB at a position shifted by the shift interval D2 from the location of the current defect F, and may set the first zone Z1 and second zone Z2 starting from the location of the current defect F. In this case, the position shifted by the shift interval D2 may be a position preceding the defect F by the shift interval D2 with respect to the first direction A1.

It is assumed that only the seventh defect F7 exists on the electrode sheet 3. The first controller 122 may recognize the location of the seventh defect F7 on the electrode sheet 3. It is assumed that no other defects F exist within the labeling cycle interval LC prior to the seventh defect F7. The first controller 122 may determine that the seventh defect F7 is not comprised in the previously set first zone Z1 or second zone Z2. The first controller 122 may control the labeler 123 to attach a fourth label LBD to indicate the seventh defect F7. In this case, the fourth label LBD may be attached at a position preceding the seventh defect F7 by the shift interval D2 in the first direction A1. In addition, the first controller 122 may set the first zone Z1 and the second zone Z2 based on the location of the seventh defect F7.

On the defect removal line 130, the electrode sheet 3 travels in the second direction A2, with the seventh defect F7 preceding and the fourth label LBD following. The defect removal line 130 may remove the unit electrode UE4 to which label LBD is attached, as well as one unit electrode UE3 continuously preceding the unit electrode UE4 with the attached label LBD. Even if the cutting point CP5 is located between the fourth label LBD and the seventh defect F7, the seventh defect F7 may be removed because the unit electrode UE4 with the fourth label LBD attached and one unit electrode UE3 continuously preceding the unit electrode UE4 in the second direction A2 are removed.

It is assumed that the seventh defect F7, an eighth defect F8, and a ninth defect F9 exist on the electrode sheet 3.

In case that the current defect F is comprised in the previously set first zone Z1 or second zone Z2, the first controller 122 may determine whether the current defect F is located within the first zone Z1, and if the current defect F is located within the first zone Z1, the first controller 122 may not attach a label LB. If the current defect F is not located within the first zone Z1, the first controller 122 may control the labeler 123 to attach a label LB at a position shifted by the shift interval D2 from the end point P2 of the second zone Z2, and may further perform the operation of setting the first zone Z1 and the second zone Z2 starting from the end point P2 of the second zone Z2. In this case, the position shifted by the shift interval D2 may be a position that precedes the defect F by the shift interval D2 in the first direction A1.

The first controller 122 may recognize the seventh defect F7, attach the fourth label LBD, and set the first zone Z1 and the second zone Z2 as described above. The first controller 122 may then recognize the eighth defect F8 and determine whether the eighth defect F8 is comprised in the previously set first zone Z1 or second zone Z2. The eighth defect F8 is located within the first zone Z1, and thus the first controller 122 may not attach a label LB. Since the eighth defect F8 is within the previously set first zone Z1, the first controller 122 does not reset the first zone Z1 and the second zone Z2.

The first controller 122 may determine, after recognizing the ninth defect F9, whether the ninth defect F9 is comprised in the previously set first zone Z1 or second zone Z2. The ninth defect F9 is not located in the first zone Z1. That is, the ninth defect F9 is located in the second zone Z2. In case that the ninth defect F9 located in the second zone Z2 is close to the end point P2 of the second zone Z2, the ninth defect F9 may not be removed even if the unit electrode UE4 to which the fourth label LBD is attached and the continuously preceding unit electrode UE3 in the second direction A2 are removed. In this case, in order to indicate a defect F existing in the second zone Z2, the first controller 122 may additionally attach a fifth label LBE at a position that precedes the end point of the second zone Z2 by the shift interval D2. In summary, the defect F8 comprised in the first zone Z1 starting from the first defect F7 may be indicated by the fourth label LBD that precedes the first defect F7 by the shift interval D2, and the defect F9 comprised in the second zone Z2 may be indicated by the fifth label LBE that precedes the end point P2 of the second zone Z2 by the shift interval D2. In addition, since the ninth defect F9 existed in the second zone Z2, the first controller 122 may set a new first zone Z1 from P2 to P3 and a new second zone Z2 from P3 to P4, starting from the end point of the second zone Z2.

On the defect removal line 130, the electrode sheet 3 travels in the second direction A2, with the ninth defect F9 preceding and the fifth label LBE following. In addition, the eighth defect F8 and the seventh defect F7 precede in sequence, and the fourth label LBD follows. Accordingly, the unit electrodes UE3 and UE4 to which the labels LBE and LBD are attached, and one unit electrode UE2 that continuously precedes the unit electrode UE3 to which the label LBE is attached, may be removed. In this way, the seventh defect F7, the eighth defect F8, and the ninth defect F9 may all be removed.

It is assumed that the seventh defect F7 to a tenth defect F10 exist on the electrode sheet 3.

The first controller 122 may attach the fourth label LBD and the fifth label LBE to the seventh defect F7 to the ninth defect F9 as described above. In addition, since the ninth defect F9 existed in the second zone Z2, the first controller 122 may set a new first zone Z1 and a new second zone Z2 starting from the end point P2 of the previous second zone Z2.

The first controller 122 may recognize the tenth defect F10 and determine that the tenth defect F10 is a line defect. The tenth defect F10 is positioned across the newly set first zone Z1 and second zone Z2 starting from P2. The first controller 122 may not attach a label LB to a portion of the tenth defect F10 located in the first zone Z1. This is because the portion of the tenth defect F10 located in the first zone Z1 can be removed by removing the unit electrode UE3 to which the fifth label LBE is attached and the unit electrode UE2 that continuously precedes the unit electrode UE3 in the second direction A2. A portion of the tenth defect F10 located in the second zone Z2 is positioned adjacent to the end point P4 of the second zone Z2 and cannot be removed by removing the unit electrode UE3 to which the fifth label LBE is attached and the unit electrode UE2 that continuously precedes the unit electrode UE3 in the second direction A2. In this case, to completely remove the tenth defect F10 existing in the second zone Z2, the first controller 122 may additionally attach a sixth label LBF at a position that precedes the end point P4 of the new second zone Z2 by the shift interval D2 in the first direction A1.

On the defect removal line 130, the electrode sheet 3 travels in the second direction A2, with the tenth defect F10 preceding and the sixth label LBF following. In addition, the ninth defect F9 precedes and the fifth label LBE follows. Furthermore, the eighth defect F8 and the seventh defect F7 precede in sequence, and the fourth label LBD follows. The defect removal line 130 may remove the unit electrodes UE2, UE3, and UE4 to which the labels LBF, LBE, and LBD are attached, and one unit electrode UE1 that continuously precedes the unit electrode UE2 to which the label LBF is attached.

As described above, the first controller 122 may attach or not attach a label LB depending on whether a defect F is located in the first zone Z1 or the second zone Z2. When an electrode roll to which a label LB indicating a defect F is attached is supplied to the defect removal line 130 in this manner, the electrode sheet 3 in which a defect F is likely to exist may be removed under the control of the second controller 134.

In case that a label LB exists on the electrode sheet 3, the second controller 134 may control the notcher 131 so as not to perform notching on a predetermined number of consecutive unit electrodes UE starting from and comprising the unit electrode UE to which the label LB is attached, with respect to the second direction A2, and may control the cutter 132 so as not to separate a predetermined number of consecutive unit electrodes UE starting from and comprising the unit electrode UE to which the label LB is attached, with respect to the second direction A2. When a portion of the electrode sheet 3 corresponding to the unit electrode UE to which the label LB is attached and the predetermined number of consecutive unit electrodes UE has passed, the second controller 134 may control the notcher 131 to perform notching to create a tab on the electrode sheet 3 in which no defect F exists, and may control the cutter 132 to cut at a predetermined interval to separate the notched electrode sheet 3 into unit electrodes UE. In this case, the second controller 134 may prevent notching and cutting from being performed on the unit electrode UE to which the label LB is attached and one consecutive unit electrode UE preceding the unit electrode UE with the label LB attached based on the second direction A2.

As described above, the operation of the defect removal line 130 will be described assuming that the seventh defect F7 to the tenth defect F10 exist.

In case that a label LB exists on the electrode sheet 3, the second controller 134 may control the notcher 131 so as not to perform notching on a predetermined number of consecutive unit electrodes UE starting from and comprising the unit electrode UE to which the label LB is attached, with respect to the second direction A2, and may control the cutter 132 so as not to separate a predetermined number of consecutive unit electrodes UE starting from and comprising the unit electrode UE to which the label LB is attached, with respect to the second direction A2. When the portion of the electrode sheet 3 corresponding to the unit electrode UE to which the label LB is attached and the predetermined number of consecutive unit electrodes UE has passed, the second controller 134 may control the notcher 131 to perform notching to create a tab on the electrode sheet 3, and may control the cutter 132 to cut at predetermined intervals to separate the notched electrode sheet 3 into unit electrodes UE. In this case, the second controller 134 may prevent notching and cutting from being performed on the unit electrode UE to which the label LB is attached and one consecutive unit electrode UE preceding the unit electrode UE with the label LB attached based on the second direction A2.

In addition, when the portion of the electrode sheet 3 corresponding to the unit electrode UE to which the label LB is attached and the predetermined number of consecutive unit electrodes UE has passed, the second controller 134 may control the picker 135 to remove a continuous portion of the electrode sheet 3 corresponding to the predetermined number of consecutive unit electrodes UE starting from and comprising the unit electrode UE to which the label LB is attached in the second direction A2.

The electrode sheet 3, with the fourth label LBD indicating the seventh defect F7 to the eighth defect F8, the fifth label LBE indicating the ninth defect F9, and the sixth label LBF indicating the tenth defect F10 attached, passes through the label sensor 133. The tenth defect F10 enters the label sensor 133 first, then the label sensor 133 senses the sixth label LBF, and the second controller 134 may recognize the position of the second label LBB. The second controller 134 may compare the position of the sixth label LBF with the position of the cutting point to identify which unit electrode the sixth label LBF is attached to. The second controller 134 may control the notcher 131 and the cutter 132 so that notching and cutting are not performed on the unit electrode UE2 to which the sixth label LBF is attached and the one continuous unit electrode UE1 preceding the unit electrode UE2. In this state, the cutter 132 may cut between the unit electrode UE1 preceding the unit electrode UE2 to which the label LBF is attached and a preceding unit electrode (not shown). The notcher 131 may not perform notching on the unit electrode UE2 to which the label LB is attached and the one continuous unit electrode UE1 preceding the unit electrode UE2 in the second direction A2.

Subsequently, after the ninth defect F9 passes through the label sensor 133, the label sensor 133 senses the fifth label LBE, and the second controller 134 may recognize the position of the fifth label LBE. The second controller 134 may compare the position of the fifth label LBE with the position of the cutting point to identify which unit electrode the fifth label LBE is attached to. The second controller 134 may control the notcher 131 and the cutter 132 so that notching and cutting are not performed on the unit electrode UE3 to which the fifth label LBE is attached and the one continuous unit electrode UE2 preceding the unit electrode UE3 in the second direction A2.

Subsequently, after the eighth defect F8 and the seventh defect F7 pass through the label sensor 133 in sequence, the label sensor 133 senses the fourth label LBD, and the second controller 134 may recognize the position of the fourth label LBD. The second controller 134 may compare the position of the fourth label LBD with the position of the cutting point to identify which unit electrode the fourth label LBD is attached to. The second controller 134 may control the notcher 131 and the cutter 132 so that notching and cutting are not performed on the unit electrode UE4 to which the fourth label LBD is attached and the one continuous unit electrode UE3 preceding the unit electrode UE4 in the second direction A2.

As a result, notching and cutting may not be performed on the four unit electrodes UE1, UE2, UE3, and UE4. The four unit electrodes UE1, UE2, UE3, and UE4 may pass through the notcher 131 and the cutter 132 while remaining connected to each other.

The second controller 134 may determine whether a predetermined number of unit electrodes have passed. After determining that the unit electrodes UE2, UE3, and UE4 to which the labels LBF, LBE, and LBD are attached, and the one continuous unit electrode UE1 preceding the unit electrode UE2 to which the label LBF is attached, have all passed, the second controller 134 may control the notcher 131 and the cutter 132 to resume notching and cutting. Accordingly, the unit electrodes UE1, UE2, UE3, and UE4, which contain defects F, may be separated from the subsequent unit electrodes (not shown) that do not contain defects F.

Due to the operations of the first controller 122 and the second controller 134 described above, even a defect F formed over an area much longer than the labeling cycle interval LC may be indicated by attaching multiple labels LB. Whether a single defect F exists or many consecutive defects F exist, only the minimum number of unit electrodes UE may be removed. In addition, a unit electrode UE containing a defect F may be prevented from being conveyed to the next process.

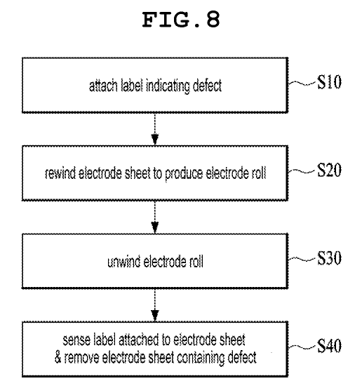

FIG. 8 is a view illustrating each step of a method for manufacturing an electrode according to an embodiment. FIG. 1 is referred to together.

The method for manufacturing an electrode according to an embodiment may comprise: a step S10 of sensing a defect F on an electrode sheet 3 traveling in a first direction A1 and attaching a label LB indicating the defect F to the electrode sheet 3 on a defect inspection line 120; a step S20 of rewinding the electrode sheet 3 that has passed through the defect inspection line 120 using a rewinder 14 to produce an electrode roll 12; a step S30 of unwinding the electrode roll 12 using an unwinder 13 so that the electrode sheet 3 travels in a second direction A2; and a step S40 of sensing the label LB attached to the electrode sheet 3 output from the unwinder 13 and removing the electrode sheet 3 containing the defect F on a defect removal line 130. The position where the label LB indicating the defect F is attached may be at a location shifted by a shift interval from the defect F with respect to the first direction A1.

The step S10 of attaching the label LB indicating the defect F to the electrode sheet 3 may be performed after the process of manufacturing the electrode sheet 3. In the manufacturing process of the electrode sheet 3, the step S10 of attaching the label LB indicating the defect F to the electrode sheet 3 may be carried out while the electrode sheet 3, on which coating, drying, and rolling have been performed, is being transferred to the rewinder 14. In the step S10 of attaching the label LB indicating the defect F to the electrode sheet 3, a defect sensor 121 captures images of the electrode, and a first controller 122 determines whether a defect F exists. The first controller 122 then controls a labeler 123 to attach a label LB at a position trailing the defect F by a shift interval D1 in the first direction A1 or at a position preceding the defect F in the second direction A2, whereby the labeler 123 may attach the label LB to the electrode sheet 3.

The electrode sheet 3 with the label LB attached enters the rewinder 14, and the rewinder 14 may perform step S20 of rewinding the electrode sheet 3 that has passed through the defect inspection line 120 to produce an electrode roll 12. The electrode roll 12 produced by the rewinder 14 may be transferred to a second unwinder 13b.

The second unwinder 13b may perform step S30 of unwinding the electrode roll 12 so that the electrode sheet 3 travels in the second direction A2. The electrode sheet 3 with the label LB attached may travel toward the defect removal line 130.

The step S40 of removing the electrode sheet 3 containing the defect F involves the defect removal line 130 removing a predetermined number of unit electrodes UE based on the label LB. The label sensor 133 senses the label LB attached to the electrode sheet 3 and provides the information to a second controller 134. The second controller 134 may control a notcher 131 and a cutter 132 to remove the unit electrode UE to which the label LB is attached, as well as the unit electrode UE immediately following or preceding the labeled unit electrode UE.

As described with reference to FIGS. 3 and 4, there is a method in which the label LB is attached to follow the defect F in the first direction by a shift interval D1. As described with reference to FIGS. 6 and 7, there is a method in which the label LB is attached to precede the defect F in the first direction by a shift interval D2. Since both methods involve the same steps for determining where to attach a label and which unit electrode to remove, the methods are described together.

In the method of attaching the label LB so as to follow the defect F by the shift interval D1 in the first direction A1, the position shifted by the shift interval D1 may be a position following the defect F by the shift interval D1 with respect to the first direction A1. In this case, the step S40 of removing the electrode sheet 3 containing the defect F may involve determining a unit electrode to which the label LB is attached and a predetermined number of unit electrodes following the unit electrode with the label LB attached with respect to the second direction A2 as a portion of the electrode sheet 3 containing defects F and removing the portion.

In the method of attaching the label LB so as to precede the defect F by the shift interval D2 in the first direction A1, the position shifted by the shift interval D2 may be a position preceding the defect F by the shift interval D2 with respect to the first direction A1. In this case, the step S40 of removing the electrode sheet 3 containing the defect F may involve determining a unit electrode to which the label LB is attached and a predetermined number of unit electrodes preceding the unit electrode with the label LB attached with respect to the second direction A2 as a portion of the electrode sheet 3 containing defects F and removing the portion.

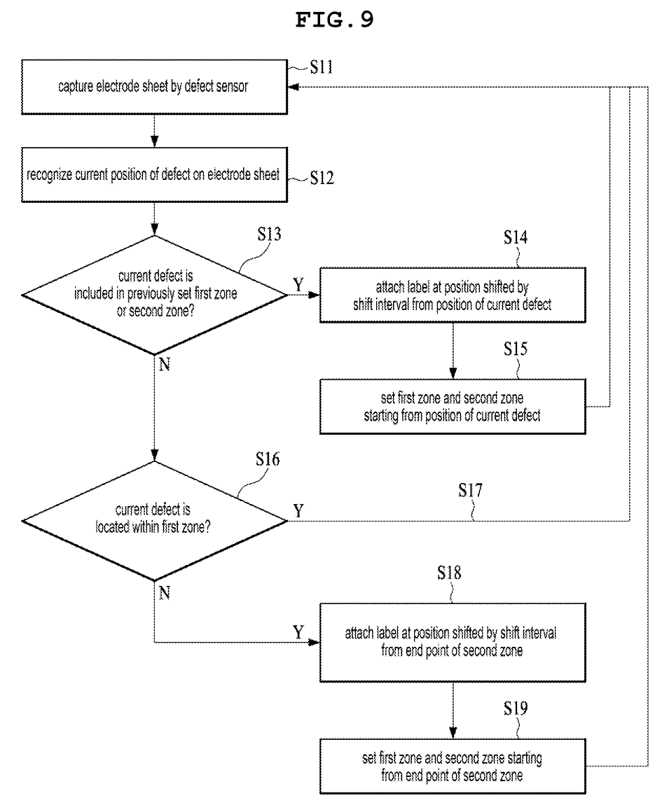

FIG. 9 is a view illustrating detailed steps of step S10 of attaching a label LB indicating a defect F according to an embodiment. FIGS. 1, 3, 4, 6, 7, and 8 are referred to together.

The step S10 of attaching the label LB indicating the defect F may comprise: a step S11 of capturing the electrode sheet 3 by a defect sensor 121; a step S12 of recognizing, by the first controller 122, a current position of a defect F on the electrode sheet 3 by analyzing images received from the defect sensor 121; a first determination step S13 of determining whether the current defect F is comprised in a previously set first zone Z1 or second zone Z2; a step S14 of attaching a label LB at a position shifted by the shift interval D1 from the position of the current defect F when the current defect F is not comprised (N in S13) in the previously set first zone Z1 or second zone Z2; and a step S15 of setting a first zone Z1 and a second zone Z2 starting from the position of the current defect F.

The step S11 of capturing the electrode sheet 3 by the defect sensor 121 involves the defect sensor 121 capturing images of the electrode sheet 3 manufactured on the electrode sheet 3 manufacturing line 110. The defect sensor 121 may transmit data generated by capturing the electrode sheet 3 to the first controller 122. The step S11 of capturing the electrode sheet 3 by the defect sensor 121 may be repeatedly performed in real time while the electrode sheet 3 is traveling.

The step S12 of recognizing the current position of the defect F involves the first controller 122 analyzing the data received from the defect sensor 121 to determine whether a defect F exists and to recognize the position of the defect F. The first controller 122 may determine whether a defect F exists on the electrode sheet 3, such as when the height of a mixture layer 2 deviates from a predetermined range, when folds, tears, or wrinkles occur on a current collector 1, or when cracks or grooves appear in the mixture layer 2. The first controller 122 may calculate the position of the current defect F by considering the travel speed of the electrode sheet 3 and the operating speeds of the defect sensor 121 and the first controller 122.

The first determination step S13 involves the first controller 122 determining whether the current defect F is comprised in a previously set first zone Z1 or second zone Z2. When a defect F is sensed, a first zone Z1 and a second zone Z2 are set based on the position of the defect F. In case that the current defect F is not comprised within the previously set first zone Z1 or second zone Z2, it means that the current defect F is the first defect F. In other words, no other defects F exist within the labeling cycle interval LC preceding the current defect F. The first controller 122 may determine that it is necessary to attach a label LB to indicate the current defect F.

The step S14 of attaching the label LB at the position shifted by the shift interval from the position of the current defect F may be performed when the current defect F is not comprised (N in S13) in the previously set first zone Z1 or second zone Z2. The fact that the current defect F is comprised in the previously set first zone Z1 or second zone Z2 means that the current defect F is the second, third, or a subsequent defect F. To indicate the current defect F, the first controller 122 may control the labeler 123 to attach a label LB at a position shifted by the shift interval from the position of the current defect F. Based on the control of the first controller 122, the labeler 123 may attach a first label LBA. The shifted position may be a position following the defect F by the shift interval D1 with respect to the first direction A1, or a position preceding the defect F by the shift interval D2 with respect to the first direction A1.

After attaching the label LB at the position shifted by the shift interval from the position of the current defect F, the first controller 122 may perform step S15 of setting a first zone Z1 and a second zone Z2 starting from the current defect F. The first controller 122 may perform step S15 of setting the first zone Z1 and the second zone Z2 by newly updating the positions of the previously set first zone Z1 and second zone Z2. The first zone Z1 and second zone Z2 may serve as a reference for determining whether to attach labels LB to defects F occurring after the first defect F.

In case that the current defect F is comprised (Y in S13) in the previously set first zone Z1 or second zone Z2, the first controller 122 may perform a second determination step S16.

The step S10 of attaching the label LB indicating the defect F may further comprise: the second determination step S16 of determining whether the current defect F is located within the first zone Z1 when the current defect F is comprised (Y in S13) in the previously set first zone Z1 or second zone Z2; a step S17, in which, when the current defect F is located within the first zone Z1 (Y in S16), no label LB is attached, and the process returns to the step of capturing the electrode sheet 3 by the defect sensor 121; a step S18, in which, when the current defect F is not located within the first zone Z1 (N in S16), a label LB is attached at a position shifted by the shift interval from an end point of the second zone Z2; and a step S19 of setting a first zone Z1 and a second zone Z2 starting from the end point of the second zone Z2. In this case, the position shifted by the shift interval may be a position following the end point of the second zone Z2 by the shift interval D1 with respect to the first direction A1, or a position preceding the end point of the second zone Z2 by the shift interval D2 with respect to the first direction A1.

The second determination step S16 involves determining whether the current defect F is located in the first zone Z1 or the second zone Z2. When the current defect F is located in the first zone Z1 (Y in S16), the first controller 122 may perform step S17, in which no label LB is attached and the process returns to step S11 of capturing the electrode sheet 3 by the defect sensor 121. That the current defect F is located in the first zone Z1 may mean that the current defect F is simultaneously indicated by a label (LBA in FIG. 4, LBD in FIG. 7) attached to indicate the first defect F. Thus, for a plurality of defects located in the first zone Z1 (F2 and F3 in FIG. 4; F8 in FIG. 9), no label LB is attached, and the process may return to step S11, in which the images provided by the defect sensor 121 are analyzed to continue determining defects F.

When the current defect F is located in the second zone Z2 (N in S16), that is, when the current defect F is in the first zone Z1 or the second zone Z2 but not within the first zone Z1, the first controller 122 may perform step S18, in which a label LB is attached at a position shifted by the shift interval from the end point of the second zone Z2. By attaching a label (LBB in FIG. 4, LBE in FIG. 7) at a position shifted by the shift interval from the end point of the second zone Z2, one or more defects comprised in the second zone Z2 (F4 and F5 in FIG. 4; F9 in FIG. 7) may be indicated.

After attaching a label LB at a position shifted by the shift interval from the end point of the second zone Z2, the first controller 122 may further perform step S19 of setting a first zone Z1 and a second zone Z2 starting from the end point of the second zone Z2. Since a label (LBB in FIG. 4, LBE in FIG. 7) has been attached to indicate the defects F present in the second zone Z2, no label LB may be attached to defects F comprised in the new first zone Z1 continuing from the second zone Z2. This is because labels LB cannot be attached consecutively within a single labeling cycle interval LC. To account for the case where defects F continue to occur, when defects F exist in the second zone Z2, a new first zone Z1 and second zone Z2 starting from the end point of the second zone Z2 may be set. The first controller 122 may perform the setting of the new first zone Z1 and second zone Z2 by updating the positions of the previously set first zone Z1 and second zone Z2.

As described with reference to FIGS. 3, 4, 6, and 7, the first controller 122 may repeatedly perform the first determination step S13, the step S14 of attaching a label LB at a position shifted by the shift interval from the current defect F, the step S15 of setting a first zone Z1 and a second zone Z2 starting from the current defect F, the second determination step S16, the step S18 of attaching a label LB at a position shifted by the shift interval from the end point of the second zone Z2, and the step S19 of setting a first zone Z1 and a second zone Z2 starting from the end point of the second zone Z2, so that one or more labels LB indicating one or more defects F may be attached to the electrode sheet 3.

The electrode sheet 3 with defects F indicated thereon is wound by the rewinder 14 to form an electrode roll 12. The electrode roll 12 is transported to the defect removal line 130, where the electrode roll 12 is unwound so that the electrode sheet 3 may travel in the second direction A2 toward the notcher 131.

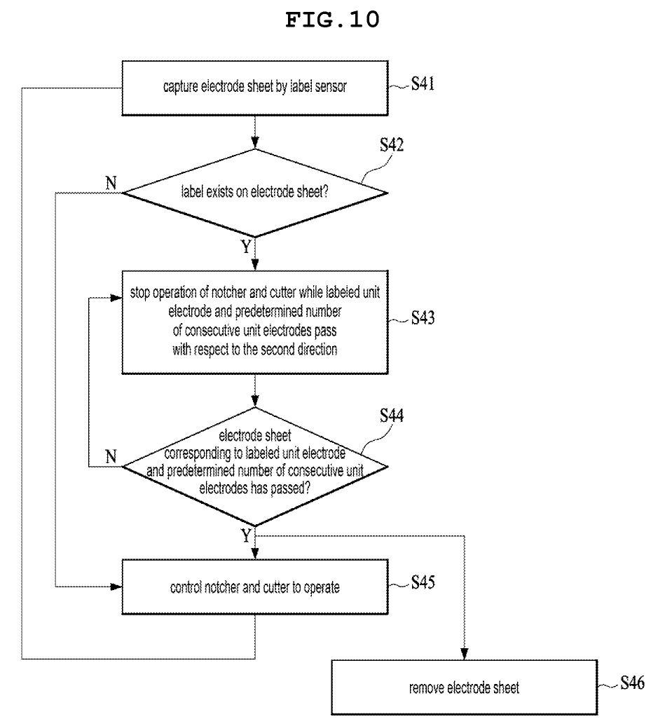

FIG. 10 is a view illustrating the detailed steps of the step S40 of removing the electrode sheet 3 according to an embodiment. FIGS. 1, 3, 4, and 8 are referred to together.

The step S40 of removing the electrode sheet 3 containing the defect F may comprise: a step S41 of capturing the electrode sheet 3 by the label sensor 133; a step S42 of determining, by the second controller 134, whether a label LB exists on the electrode sheet 3 by analyzing images received from the label sensor 133; a step S43, in which, when a label LB exists on the electrode sheet 3, the second controller 134 controls the notcher 131 so as not to perform notching on a labeled unit electrode and a predetermined number of consecutive unit electrodes immediately following or preceding the labeled unit electrode with respect to the second direction A2, and controls the cutter 132 so as not to separate the labeled unit electrode and the predetermined number of consecutive unit electrodes following the labeled unit electrode with respect to the second direction A2; a step S44 of determining whether a portion of the electrode sheet 3 corresponding to the labeled unit electrode and the predetermined number of consecutive unit electrodes has passed; a step S45, in which, when the portion of the electrode sheet 3 corresponding to the labeled unit electrode and the predetermined number of consecutive unit electrodes has passed, the second controller 134 controls the notcher 131 to perform notching on the electrode sheet 3 to create a tab, and controls the cutter 132 to cut the notched electrode sheet 3 at predetermined intervals to separate the notched electrode sheet 3 into unit electrodes; and a step S46, in which, when the portion of the electrode sheet 3 corresponding to the labeled unit electrode and the predetermined number of consecutive unit electrodes has passed, the second controller 134 removes a continuous portion of the electrode sheet 3 corresponding to the unit electrode to which the label LB is attached and the predetermined number of consecutive unit electrodes in the second direction A2.

In addition, the step S40 of removing the electrode sheet 3 in which a defect F is present may involve determining that a unit electrode to which a label LB is attached and a predetermined number of unit electrodes trailing the unit electrode with respect to the second direction A2 are a portion of the electrode sheet 3 in which a defect F is present and removing the portion, or determining that a unit electrode to which a label LB is attached and a predetermined number of unit electrodes preceding the unit electrode with respect to the second direction A2 are a portion of the electrode sheet 3 in which a defect F is present and removing the portion.

The step S41 of capturing the electrode sheet 3 by the label sensor 133 involves the label sensor 133 capturing images of the electrode sheet 3 output from the second unwinder 13b. The label sensor 133 may capture an image of a position on the electrode sheet 3 at which the label LB is attached and provide the generated data to the second controller 134.

The step S42 of determining whether a label LB exists on the electrode sheet 3 involves the second controller 134 analyzing data received from the label sensor 133 to determine whether a label LB is present. When the second controller 134 determines that the label LB is present on the electrode sheet 3, the second controller 134 may recognize the position of the label LB. The second controller 134 may match the stored size E of the unit electrode UE with the position of the label LB to identify which unit electrode UE the label LB is attached to.

When the label LB is not present on the electrode sheet 3 (N in step S42), the second controller 134 may perform step S45 of controlling the notcher 131 to perform notching to create a tab on the electrode sheet 3, and controlling the cutter 132 to cut the notched electrode sheet 3 at predetermined intervals to separate the notched electrode sheet 3 into unit electrodes.

When the label LB is present on the electrode sheet 3 (Y in step S42), the second controller 134 may perform a pass step S43. In the pass step S43, the second controller 134 controls the notcher 131 so as not to perform notching on a predetermined number of consecutive unit electrodes starting from and comprising a unit electrode with the label LB attached, with respect to the second direction A2, and controls the cutter 132 so as not to separate the predetermined number of consecutive unit electrodes starting from and comprising the unit electrode with the label LB attached, with respect to the second direction A2.

In case that, in the step S40 of removing the electrode sheet 3 in which a defect F is present, a unit electrode to which the label LB is attached and a predetermined number of unit electrodes trailing the unit electrode with respect to the second direction A2 are determined to be a portion of the electrode sheet 3 in which the defect F is present and are to be removed, in the pass step S43, the second controller 134 may control the notcher 131 so as not to perform notching on the unit electrode UE to which the label LB is attached and one consecutive unit electrode UE trailing the unit electrode to which the label LB is attached in the second direction A2. In addition, the second controller 134 may control the cutter 132 so as not to separate the unit electrode UE to which the label LB is attached and one consecutive unit electrode UE trailing the unit electrode to which the label LB is attached in the second direction A2. Accordingly, a faulty electrode FE connected over the size E of the two unit electrodes UE may be formed.

In case that, in the step S40 of removing the electrode sheet 3 in which a defect F is present, a unit electrode to which the label LB is attached and a predetermined number of unit electrodes preceding the unit electrode with respect to the second direction A2 are determined to be a portion of the electrode sheet 3 in which the defect F is present and are to be removed, in the pass step S43, the second controller 134 may control the notcher 131 so as not to perform notching on the unit electrode UE to which the label LB is attached and one consecutive unit electrode UE preceding the unit electrode to which the label LB is attached in the second direction A2. In addition, the second controller 134 may control the cutter 132 so as not to separate the unit electrode UE to which the label LB is attached and one consecutive unit electrode UE preceding the unit electrode to which the label LB is attached in the second direction A2. Accordingly, a faulty electrode FE connected over the size E of the two unit electrodes UE may be formed.

The label sensor 133 is positioned adjacent to the second unwinder 13b, and the distance between the label sensor 133 and the notcher 131 may be set larger than the labeling cycle interval LC. Thus, when a label LB is sensed by the label sensor 133, and a label LB is present after a distance corresponding to the labeling cycle interval LC, the second controller 134 may continue to control the notcher 131 and the cutter 132 so as not to operate. When labels LB continue to be present at positions spaced apart by the labeling cycle interval LC, the second controller 134 may continue to perform the pass step S43 so that the notcher 131 and the cutter 132 do not operate. As a result, two or more unit electrodes UE may pass through the notcher 131 and the cutter 132 without being separated from each other.

The second controller 134 may perform step S44 of determining whether a portion of the electrode sheet 3 corresponding to the unit electrode to which the label LB is attached and a predetermined number of consecutive unit electrodes has passed. When the removal of two unit electrodes UE starting from (comprising) the unit electrode UE to which the label LB is attached is set, the second controller 134 may determine, based on the size E of the unit electrode UE, whether the electrode sheet 3 corresponding to two unit electrodes UE has passed. In case that the electrode sheet 3 has not passed by a length corresponding to two unit electrodes UE (N in step S44), the process may return to the pass step S43 so that operation of the notcher 131 and the cutter 132 is stopped. When a label LB continues to be present at each labeling cycle interval LC, the second controller 134 may continuously return to the pass step S43.

When a portion of the electrode sheet 3 corresponding to the unit electrode to which the label LB is attached and a predetermined number of consecutive unit electrodes has passed (Y in step S44), the second controller 134 may perform step S45 of controlling the notcher 131 and the cutter 132 to operate. The second controller 134 may operate the notcher 131 to perform notching and operate the cutter 132 to perform cutting when a portion corresponding to the unit electrode UE to which the label LB is attached passes through the notcher 131. When the notcher 131 and the cutter 132 operate, a faulty electrode FE to which the label LB is attached and which is in a consecutive state may be separated from a unit electrode UE without a defect F.

When a portion of the electrode sheet 3 corresponding to the unit electrode to which the label LB is attached and a predetermined number of consecutive unit electrodes has passed (Y in step S44), the second controller 134 may perform step S46 of removing the electrode sheet 3, that is, a faulty electrode FE, to which the label LB is attached and which comprises a defect F while remaining connected without being notched. The second controller 134 may control the picker 135 to pick up the faulty electrode FE continuous over a predetermined number of unit electrodes UE starting from and comprising the unit electrode UE to which the label LB is attached in the second direction A2 and transfer the faulty electrode FE to a discharge location. The faulty electrode FE transferred to the discharge location may be removed. The picker 135 may be a pick-and-place device. The picker 135 may lift a faulty electrode FE from the transport system 15 and place the faulty electrode FE at the discharge location.

According to the description, in the apparatus 100 and method for manufacturing an electrode, by attaching a label LB indicating a defect F such that the label LB trails by a shift interval D1, it is possible in the defect removal line 130 to ensure that the defect F does not precede the label LB. As a result, a unit electrode UE in which a defect F is present may be prevented from being transferred to the next process. Furthermore, by removing only the unit electrode UE to which the label LB is attached and one consecutive unit electrode UE trailing the unit electrode UE with the label LB attached, a total of only two unit electrodes UE need to be removed, thereby minimizing the number of electrodes being removed.

The above has been described in detail through specific embodiments. The foregoing description is merely an example to which the principles of the present disclosure are applied, and other configurations may be comprised within the scope of the present disclosure without departing from the spirit of the present disclosure.

What is claimed is:

1. An apparatus for manufacturing an electrode, the apparatus comprising:
a defect inspection line configured to sense a defect in an electrode sheet traveling in a first direction and attach a label indicating the defect to the electrode sheet;
a rewinder configured to rewind the electrode sheet having passed through the defect inspection line to produce an electrode roll;
an unwinder configured to unwind the electrode roll and cause the electrode sheet to travel in a second direction; and
a defect removal line configured to sense the label attached to the electrode sheet output from the unwinder and remove a portion of the electrode sheet in which the defect is present,
wherein a position at which the label indicating the defect is attached is a position shifted from the defect by a shift interval based on the first direction.

2. The apparatus of claim 1, wherein the defect inspection line comprises:
a defect sensor configured to capture the electrode sheet;
a labeler configured to attach a label to the electrode sheet; and
a first controller configured to analyze images captured by the defect sensor to determine whether a defect is present in the electrode sheet and control the labeler to attach a label to the electrode sheet.

3. The apparatus of claim 2, wherein the first controller analyzes images received from the defect sensor to recognize a position of a current defect on the electrode sheet and determines whether the current defect is comprised in a previously set first zone or second zone, and in case that the current defect is not comprised in the previously set first zone or second zone, controls the labeler to attach a label at a position shifted by the shift interval from the position of the current defect, and sets a first zone and a second zone starting from the position of the current defect.

4. The apparatus of claim 3, wherein in case that the current defect is comprised in the previously set first zone or second zone, the first controller determines whether the current defect is located within the first zone, and controls the labeler so as not to attach a label when the current defect is located in the first zone, and controls the labeler to attach a label at a position shifted by the shift interval from an end point of the second zone when the current defect is not located within the first zone, and further performs an operation of setting a first zone and a second zone starting from the end point of the second zone.

5. The apparatus of claim 1, wherein the defect removal line comprises:
a label sensor configured to sense a label attached to the electrode sheet traveling in the second direction from the unwinder;
a notcher configured to perform notching to create a tab on the electrode sheet;
a cutter configured to cut the electrode sheet to separate the sheet into unit electrodes; and
a second controller that, when a label is present on the electrode sheet, controls the notcher so as not to perform notching on a predetermined number of consecutive unit electrodes starting from and comprising a unit electrode to which the label is attached, based on the second direction, and controls the cutter so as not to separate the predetermined number of consecutive unit electrodes starting from and comprising the unit electrode to which the label is attached, based on the second direction, and that, when a portion of the electrode sheet corresponding to the unit electrode to which the label is attached and the predetermined number of consecutive unit electrodes has passed, controls the notcher to perform notching to create a tab on a portion of the electrode sheet without a defect, and controls the cutter to cut the notched electrode sheet at predetermined intervals to separate the sheet into unit electrodes.

6. The apparatus of claim 1, wherein the position shifted by the shift interval is a position trailing the defect by the shift interval with respect to the first direction, and
the defect removal line removes a unit electrode to which the label is attached and a predetermined number of unit electrodes trailing the unit electrode to which the label is attached with respect to the second direction after determining the unit electrode to which the label is attached and the predetermined number of unit electrodes trailing the unit electrode to which the label is attached to be a portion of the electrode sheet in which a defect is present.

7. The apparatus of claim 6, wherein the shift interval is set within a range in which a minimum value corresponds to a length of a first zone corresponding to a minimum labeling interval of a labeler plus an error gap during label attachment by the labeler, and a maximum value corresponds to a size of a unit electrode.

8. The apparatus of claim 1, wherein the position shifted by the shift interval is a position preceding the defect by the shift interval with respect to the first direction, and
the defect removal line removes a unit electrode to which the label is attached and a predetermined number of unit electrodes preceding the unit electrode to which the label is attached with respect to the second direction after determining the unit electrode to which the label is attached and the predetermined number of unit electrodes preceding the unit electrode to which the label is attached to be a portion of the electrode sheet in which a defect is present.

9. The apparatus of claim 8, wherein the shift interval is set to a length of an error gap during label attachment by a labeler.

10. A method for manufacturing an electrode, the method comprising:
sensing, on a defect inspection line, a defect in an electrode sheet traveling in a first direction and attaching a label indicating the defect to the electrode sheet;
rewinding, by a rewinder, the electrode sheet having passed through the defect inspection line to produce an electrode roll;
unwinding, by an unwinder, the electrode roll so that the electrode sheet travels in a second direction; and
sensing, on a defect removal line, the label attached to the electrode sheet output from the unwinder and removing a portion of the electrode sheet in which the defect is present,
wherein a position at which the label indicating the defect is attached is a position shifted from the defect by a shift interval based on the first direction.

11. The method of claim 10, wherein the attaching of the label indicating the defect comprises:
capturing, by a defect sensor, the electrode sheet;
recognizing, by a first controller, a position of a current defect on the electrode sheet by analyzing images received from the defect sensor;
determining (a first determination step) whether the current defect is comprised in a previously set first zone or second zone;
attaching a label at a position shifted by the shift interval from the position of the current defect in case that the current defect is not comprised in the previously set first zone or second zone; and
setting a first zone and a second zone starting from the position of the current defect.

12. The method of claim 11, wherein the attaching of the label indicating the defect further comprises:
determining (a second determination step) whether the current defect is located within the first zone when the current defect is comprised in the previously set first zone or second zone;
not attaching, in case that the current defect is located within the first zone, the label and returning to the capturing of the electrode sheet, in which the defect sensor captures the electrode sheet;
attaching, in case that the current defect is not located within the first zone, the label at a position shifted by the shift interval from an end point of the second zone; and
setting a first zone and a second zone starting from the end point of the second zone.

13. The method of claim 10, wherein the removing of the portion of the electrode sheet in which the defect is present comprises:
capturing, by a label sensor, the electrode sheet;
determining, by a second controller, whether a label is present on the electrode sheet by analyzing images received from the label sensor;
controlling (a pass step), by the second controller, a notcher so as not to perform notching on a predetermined number of consecutive unit electrodes starting from and comprising a unit electrode to which the label is attached, based on the second direction, and a cutter so as not to separate the predetermined number of consecutive unit electrodes starting from and comprising the unit electrode to which the label is attached, based on the second direction, in case that the label is present on the electrode sheet;
determining, by the second controller, whether a portion of the electrode sheet corresponding to the unit electrode to which the label is attached and the predetermined number of consecutive unit electrodes has passed;
controlling, by the second controller, the notcher to perform notching to create a tab on the electrode sheet, and the cutter to cut the notched electrode sheet at predetermined intervals to separate the notched electrode sheet into unit electrodes, in case that the portion of the electrode sheet corresponding to the unit electrode to which the label is attached and the predetermined number of consecutive unit electrodes has passed; and
removing, by the second controller, a continuous portion of the electrode sheet corresponding to the unit electrode to which the label is attached and the predetermined number of consecutive unit electrodes in the second direction, in case that the portion of the electrode sheet corresponding to the unit electrode to which the label is attached and the predetermined number of consecutive unit electrodes has passed.

14. The method of claim 10, wherein the position shifted by the shift interval is a position trailing the defect by the shift interval with respect to the first direction, and
the removing of the portion of the electrode sheet in which the defect is present involves removing a unit electrode to which the label is attached and a predetermined number of unit electrodes trailing the unit electrode to which the label is attached with respect to the second direction after determining the unit electrode to which the label is attached and the predetermined number of unit electrodes trailing the unit electrode to which the label is attached to be a portion of the electrode sheet in which a defect is present.

15. The method of claim 10, wherein the position shifted by the shift interval is a position preceding the defect by the shift interval with respect to the first direction, and
the removing of the portion of the electrode sheet in which the defect is present involves removing a unit electrode to which the label is attached and a predetermined number of unit electrodes preceding the unit electrode to which the label is attached with respect to the second direction after determining the unit electrode to which the label is attached and the predetermined number of unit electrodes preceding the unit electrode to which the label is attached to be a portion of the electrode sheet in which a defect is present.
